(19) United States
(12) Patent Application Publication
(10) Pub. No.: US 2024/0381881 A1
(43) Pub. Date: Nov. 21, 2024

(54) SYSTEM AND METHOD FOR SMART MANUFACTURING

(71) Applicant: Cargill, Incorporated, Wayzata, MN (US)

(72) Inventors: Nathaniel J. Birkhofer, Wichita, KS (US); Leon Fletcher, Andover, KS (US); Jarrod Gillig, Blue Rapids, KS (US); Cade W. Schoonover, Wichita, KS (US); Brett Walters, Fremont, NE (US)

(73) Assignee: Cargill, Incorporated, Wayzata, MN (US)

(21) Appl. No.: 18/570,759

(22) PCT Filed: Jul. 7, 2022
(86) PCT No.: PCT/US2022/073507

§ 371 Date: Dec. 15, 2023

Related U.S. Application Data
(60) Provisional application No. 63/219,477, filed on Jul. 8, 2021.

(51) Int. Cl. A22C 17/00; G06T 7/00; G06T 7/246; G06V 10/764; G06V 10/77; G06V 40/20; G08B 21/02; H04N 7/18

(52) U.S. Cl. CPC A22C 17/008; A22C 17/0093; G06T 7/001; G06T 7/246; G06V 40/23; H04N 7/183; G06T 2207/30128; G06T 2207/30196; G06V 10/764; G06V 10/7715; G08B 21/02

(57) ABSTRACT

A system and method include a first computer vision system to capture first image data from a product travelling on a first conveyor table in a food processing facility and a second computer vision system to capture second image data from a person working at the first conveyor table to detect a condition associated with the product from the first image data based at least on a variation in texture and/or color in the first image data, detect an actual cycle time associated with the person from the second image data based at least on body positions identified from the second image data, and take action based on the condition and the cycle time.

### CROSS-REFERENCE TO RELATED APPLICATIONS

This application claims the benefit of U.S. Provisional Patent Application No. 63/219,477, filed 8 Jul. 2021, which is hereby incorporated by reference in its entirety.

### BACKGROUND

Commercial food production is performed in a number of stages. For example, meat (e.g., beef) production involves a variety of steps starting with an animal and leading to a packaged meat product. An animal that is fit for human consumption is slaughtered and harvested (e.g., skinned, internal organs removed, blood drained, aged, etc.) before being cut into pieces for making consumable food products. For example, in some embodiments, beef may be cut into chuck, rib, loin, and round pieces. Various food processing and packaging operations and inspections may be performed on the meat before packaged food products are shipped out.

### SUMMARY

Various aspects of the disclosure may now be described with regard to certain examples and embodiments, which are intended to illustrate but not limit the disclosure. Although the examples and embodiments described herein may focus on, for the purpose of illustration, specific systems and processes, one of skill in the art may appreciate the examples are illustrative only, and are not intended to be limiting.

In accordance with some embodiments of the present disclosure, a method is disclosed. The method includes receiving, by a controller, image data captured from a product traveling on a conveyor table in a food processing facility, determining, by the controller, at least one of a presence of a foreign object embedded within the product, a trim composition of the product, or an amount of meat on the product based on variations in texture and/or color identified from the image data, and taking, by the controller, an action based on the determined presence of the foreign object embedded within the product, the trim composition of the product, or the amount of meat on the product.

In accordance with further embodiments of the present disclosure, another method is disclosed. The method includes receiving, by a controller, image data captured from a vacuum sealed package moving on a conveyor table in a food processing facility, determining, by the controller, a defect inside the vacuum sealed package based on the image data, activating, by the controller, a diverter gate to divert the vacuum sealed package for repackaging upon detecting the defect in the vacuum sealed package, computing, by the controller, a rework rate based upon a number of packages that are diverted for repackaging upon diverting the vacuum sealed package for repackaging, and raising, by the controller, an alert upon determining that the rework rate is greater than a threshold rework rate.

In accordance with further embodiments of the present disclosure, a system is disclosed. The system includes a first computer vision system to capture first image data from a product travelling on a first conveyor table in a food processing facility a second computer vision system to capture second image data from a worker working at the first conveyor table, a memory having computer-readable instructions stored thereon, and a processor that executes the computer-readable instructions to detect a condition associated with the product from the first image data based at least on a variation in texture and/or color in the first image data, detect an actual cycle time associated with the worker from the second image data based at least on body positions of the worker identified from the second image data, and take action based on the condition and the cycle time.

The foregoing summary is illustrative only and is not intended to be in any way limiting. In addition to the illustrative aspects, embodiments, and features described above, further aspects, embodiments, and features may become apparent by reference to the following drawings and the detailed description.

### BRIEF DESCRIPTION OF THE DRAWINGS

FIG. 1 is an example block diagram of a food processing facility, in accordance with some embodiments of the present disclosure.

FIG. 2 is an example block diagram of a smart manufacturing system implemented in the food processing facility of FIG. 1, in accordance with some embodiments of the present disclosure.

FIG. 3 is an example flowchart outlining operations of a process for detecting various undesirable conditions in the food processing facility of FIG. 1 using the smart manufacturing system of FIG. 2 and taking action based upon the detected undesirable condition, in accordance with some embodiments of the present disclosure.

FIG. 4 is another example flowchart outlining a process for taking action based upon detecting foreign objects embedded within a meat product, in accordance with some embodiments of the present disclosure.

FIGS. 5A-5D are example images showing various types of foreign objects embedded within a meat product, in accordance with some embodiments of the present disclosure.

FIG. 6 is an example flowchart outlining operations of a process for taking action based upon determining variations in a trim composition of meat, in accordance with some embodiments of the present disclosure.

FIG. 7 is an example flowchart outlining operations of a process for sorting meat based upon a trim composition of the meat, in accordance with some embodiments of the present disclosure.

FIG. 8 is an example flowchart outlining operations of a process for taking action based upon determining an amount of meat in a waste trim, in accordance with some embodiments of the present disclosure.

FIG. 9 is an example flowchart outlining operations of a process for diverting packages for repackaging upon detecting defects in the packages, as well as taking action based on rework rates, in accordance with some embodiments of the present disclosure.

FIG. 10 is an example flowchart outlining operations of a process for taking action based upon a determined throughput of a conveyor table, in accordance with some embodiments of the present disclosure.

FIG. 11 is an example flowchart outlining operations of a process for identifying inefficiencies in workers operation, in accordance with some embodiments of the present disclosure.

FIG. 12 is an example screenshot of a dashboard, in accordance with some embodiments of the present disclosure.

The foregoing and other features of the present disclosure may become apparent from the following description and appended claims, taken in conjunction with the accompanying drawings. Understanding that these drawings depict only several embodiments in accordance with the disclosure and are therefore, not to be considered limiting of its scope, the disclosure may be described with additional specificity and detail through use of the accompanying drawings.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It may be readily understood that the aspects of the present disclosure, as generally described herein, and illustrated in the figures, may be arranged, substituted, combined, and designed in a wide variety of different configurations, all of which are explicitly contemplated and made part of this disclosure.

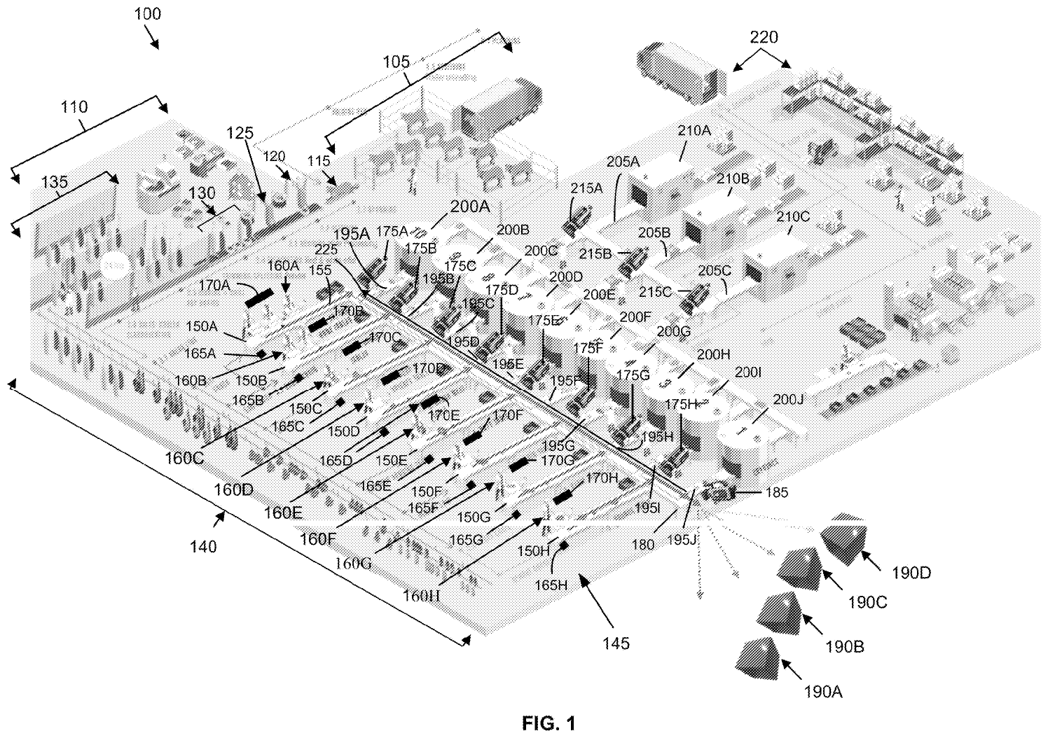

Referring to FIG. 1, an example block diagram of a food processing facility 100 is shown, In accordance with some embodiments of the present disclosure. As shown, the food processing facility 100 is a beef processing facility configured to produce beef food products. In other embodiments, the food processing facility 100 may be configured to produce other types of meat food products or non-meat food products. The food processing facility 100 produces beef food products in a variety of stages. For example, the food processing facility 100 receives animals (e.g., cows) suitable for consumption at operation 105. Each animal goes through a series of pre-processing or harvesting stages at operation 110. For example, in some embodiments, an animal may be stunned at operation 115, blood drained at operation 120, hide removed at operation 125, trimmed and split at operation 130, and hung to cool (e.g., age) at operation 135. Other pre-processing or harvesting operations not shown herein may also be performed. For example, in some embodiments, animals may be rinsed at various points to remove dust, debris, blood, or other undesirable particles or matter. In some embodiments, internal organs of the animals may be removed. In other embodiments, other or additional harvesting operations may be performed on the animals at the operation 110.

The trimmed and cooled meat from the operation 110 may be transported at operation 140 for further processing or fabrication. The operation 140 may include cutting the meat into various cuts (e.g., chuck, rib, loin, round) and moving the meat to a plurality of stations 145. Although eight stations are shown in FIG. 1, in other embodiments, greater than or fewer than eight stations may be provided. Each of the plurality of stations 145 may be configured to receive meat for processing (e.g., trimming, slicing, etc.). In some embodiments, each of the plurality of stations 145 may be configured to receive a particular type of cut of the meat for processing. In other embodiments, each of the plurality of stations 145 may be configured to perform a particular type of processing on the meat.

Each of the plurality of stations 145 may include a conveyor table 150A-150H. In some embodiments, one or more of the plurality of stations 145 may include multiple conveyor tables. In some embodiments, each of the conveyor tables 150A-150H may be an open flat top conveyor of a predetermined length and moving in a predetermined direction at a predetermined rate. For example, in some embodiments, one or more of the conveyor tables 150A-150H may be move at a rate of about 60-90 feet per minute. In other embodiments, one or more of the conveyor tables 150A-150H may move at other rates. Meat may be placed on the open flat top of the conveyor tables 150A-150H. As the meat on each of the conveyor tables 150A-150H travels in a direction 155, workers 160A-160H on one or both sides of each conveyor table perform various treatments on the meat.

Further, in some embodiments, each of the plurality of stations 145 may be associated with one or more data monitoring and gathering systems that are configured to monitor and collect data from the conveyor tables 150A-150H. For example, in some embodiments, the conveyor tables 150A-150H may be associated with sensors 165A-165H, respectively, configured to measure one or more real-time operating characteristics of the conveyor table with which those sensors are associated. For example, in some embodiments, the sensors 165A-165H may be configured to monitor a speed at which a top of a respective one of the conveyor tables 150A-150H is moving, a weight of the meat on the conveyor table, a load/unload or cycles times of the meat (e.g., the amount of time meat spends on a conveyor table from the time the meat is put on the conveyor table and the time that the meat is removed from the conveyor table), etc.

Although each of the conveyor tables 150A-150H is shown to be associated with a single one of the sensors 165A-165H, in other embodiments, one or more of the conveyor tables may include multiple sensors. In some embodiments, one or more of the sensors 165A-165H may be configured to measure a single operating characteristic from the associated one of the conveyor tables 150A-150H. In other embodiments, one or more of the sensors 165A-165H may be configured to measure multiple operating characteristics from the associated one of the conveyor tables 150A-150H. Further, although the sensors 165A-165H have been shown as being connected to one end of the respective one of the conveyor tables 150A-150H, in other embodiments, one or more of those sensors may be positioned at other locations of the respective conveyor table, including being positioned near (e.g., above, below, etc.) the respective conveyor table. Generally speaking, each of the sensors 165A-165H may be positioned relative to the respective one of the conveyor tables 150A-150H at a location that is suitable for measuring the operating characteristic of the respective conveyor table that the sensor is configured to measure.

In some embodiments, the workers 160A-160H may also have data monitoring and gathering systems associated therewith. Such data monitoring and gathering systems may be configured to capture real-time data from the workers as they process the meat. For example, in some embodiments, the data monitoring and gathering systems may include computer vision systems 170A-170H that are positioned to capture data of the workers as they work. In some embodiments, the computer vision systems 170A-170H may capture images of the faces of the workers 160A-160H. In some embodiments, the computer vision systems 170A-170H may capture the body positions of the workers 160A-160H, the distance between two workers, distance between workers and the associated conveyor table, location of the workers relative to the respective conveyor table, the side (e.g., left or right) of the conveyor table that the workers are standing, etc. In some embodiments, the computer vision systems 170A-170H may capture static images or videos. Thus, in some embodiments, the computer vision systems 170A-170H may include cameras (to take images or videos), scanning devices (e.g., to capture X-ray images, etc.), or other types of image and video gathering devices.

In some embodiments, the computer vision systems 170A-170H may be located relative to the workers 160A-160H at a location that provides a suitable view of the workers for capturing the characteristic that those computer vison systems are designed to capture. In some embodiments, one computer vision device (e.g., camera) may be provided to monitor and capture data from one worker. Thus, for monitoring and capturing data from multiple workers, multiple computer vision devices per station may be used. In other embodiments, a single computer vision system may be configured to monitor and capture data from multiple workers.

In some embodiments, the data monitoring and gathering systems for monitoring the workers 160A-160H may also include location sensors (not shown in FIG. 1) such as global positioning system devices, radio frequency tags or beacons, or any other device that may indicate the location of the workers. In some embodiments, such location sensing devices may be embedded within an implement (e.g., clothing, hard hat, shoes, watch, etc.) of the workers 160A-160H. In other embodiments, the location sensing devices may include geo fences that track the location of the workers 160A-160H relative to the conveyor tables 150A-150H. Thus, the data monitoring and gathering systems for the workers 160A-160H may include a variety of devices for capturing one or more characteristics of the workers 160A-160H.

Further, at the end of each of the conveyor tables 150A-150H, computer vision systems 175A-175H may be provided for monitoring and capturing data from meat as the meat exits the respective conveyor table to a combined conveyor table 180. In some embodiments, each of the plurality of stations 145 may be associated with a single one of the computer vision systems 175A-175H. In other embodiments, each of the plurality of stations 145 may be associated with multiple computer vision systems or multiple stations may be monitored by a single computer vision system. In some embodiments, the computer vision systems 175A-175H may include cameras (to take images or videos), scanning devices (e.g., to capture X-ray images, etc.), or other types of image and video gathering devices.

In some embodiments, the computer vision systems 175A-175H may be configured to collect image (or video) data from meat exiting the respective one of the conveyor tables 150A-150H, as well as the meat traveling on the combined conveyor table 180. Thus, in some embodiments, the computer vision systems 175A-175H may be positioned at an end of the conveyor tables 150A-150H where those conveyor tables join the combined conveyor table 180. Further, in some embodiments, at the end of the conveyor tables 150A-150H, the computer vision systems 175A-175H may be positioned at a location that provides an optimum view of the meat existing the conveyor tables 150A-150H. For example, in some embodiments, the computer vision systems 175A-175H may be located above or over a respective one of the conveyor tables 150A-150H that a particular computer vision system is designed to collect data from. In other embodiments, the computer vision systems 175A-175H may be located at other positions at the end of the conveyor tables 150A-150H or possibly at locations other than the end of those conveyor tables.

In some embodiments, a computer vision system 185 may also be positioned at the end of the combined conveyor table 180 to facilitate sorting of the meat into combos or bins 190A-190D. In some embodiments, the computer vision system 185 may include cameras (to take images or videos), scanning devices (e.g., to capture X-ray images, etc.), or other types of image and video gathering devices. Although a single instance of the computer vision system 185 is shown at the end of the combined conveyor table 180, in other embodiments, multiple computer vision systems positioned at the end of the combined conveyor table or at other locations along the combined conveyor table may also be used. Additionally, although a single instance of the combined conveyor table 180 is shown in FIG. 1, in some embodiments, two combined conveyor tables may be provided-one for lean meat (e.g., meat having a greater than a predetermined percentage of lean content) and one for fat product (e.g., meat having a greater than a predetermined percentage of fat content). In some embodiments, more than two combined conveyor tables may be used.

In some cases, meat from the combined conveyor table 180 may also lead to conveyor tables 195A-195J, which in turn may lead to vacuum packaging stations 200A-200J. Although 10 of the conveyor tables 195A-195J are shown leading to 10 of the vacuum packaging stations 200A-200J, in some embodiments, more than 10 or less than 10 conveyor tables leading to more than 10 or less than 10 vacuum packaging stations may be used. The conveyor tables 195A-195J may also be manned by workers who may be monitored similar to the workers 160A-160H. Vacuum packaged meat from the vacuum packaging stations 200A-200J may move to conveyor tables 205A-205C for being boxed and prepared for shipment. Although 3 of the conveyor tables 205A-205C are shown, in other embodiments, greater than 3 or fewer than 3 conveyor tables may be used between the vacuum packaging stations 200A-200J and stations 210A-210C.

Further, in some embodiments, as the vacuum packaged meat exits the vacuum packaging stations 200A-200J and onto the conveyor tables 205A-205C, computer vision systems 215A-215C may be used to monitor and collect data from the vacuum sealed packages travelling on those conveyor tables. In some embodiments, the computer vision systems 215A-215C may include cameras (to take images or videos), scanning devices (e.g., to capture X-ray images, etc.), or other types of image and video gathering devices. In some embodiments, the computer vision systems 215A-215C may be strategically located at a position that allows for an optimum view of the vacuum sealed packages exiting the vacuum packaging stations 200A-200J. Although one computer vision system for each of the conveyor tables 205A-205C is shown, in other embodiments, greater than one computer vision system for each of the conveyor tables 205A-205C may be used. In some embodiments, a single computer vision system may be used to collect data from multiple ones of the conveyor tables 205A-205C. Upon being packaged for shipping (e.g., loaded on pallets), the packaged meat may be shipped out at operation 220.

In some embodiments, the food processing facility 100 may also include one or more waste stream conveyor tables that carry waste product from the conveyor tables 150A-150H to a waste combo (not shown). In some embodiments, the waste stream conveyor tables may run parallel to the combined conveyor table 180 in a direction shown by arrow 225. In some embodiments, the waste stream conveyor tables may be located in other or additional locations as desired.

It is to be understood that only certain components of the food processing facility 100 are shown in FIG. 1. Nonetheless, the food processing facility 100 may include other or additional components that may be needed or considered desirable. In some embodiments, the present disclosure may be applicable to other non-food processing applications as well. Further, although only some of the components (e.g., the conveyor tables 150A-150H, the workers 160A-160H, the combined conveyor table 180, etc.) are shown and described in FIG. 1, as being monitored, in other embodiments, other components of the food processing facility 100 may similarly be monitored by providing one or more sensors, computer vision systems, or other data gathering and monitoring systems. For example, boxes containing vacuum sealed packages may be monitored for weight, specifications, etc. Additionally, although certain components of FIG. 1 are described as being monitored only by sensors (e.g., the sensors 165A-165H) or only by computer vision systems (e.g., the computer vision systems 175A-175H), or by both (e.g., the workers 160 being monitored by sensors and the computer vision systems 170A-170H), in other embodiments, one or more of those components may be monitored in additional or other ways.

By continuously monitoring and collecting data from the various components of the food processing facility 100, the operation of the food processing facility 100 may be greatly improved. For example, in some embodiments, by continuously monitoring and collecting data from the food processing facility 100, quality defects and yield performance may be measured. In some embodiments, real-time performance may be displayed to front line production teams via digital performance boards. In some embodiments, appropriate management workers may be notified if tolerances exceed an established threshold requiring immediate action. In some embodiments, product may be diverted for repackaging, etc. In some embodiments, the monitoring may identify defects in packaged goods, bottlenecks or downtimes, and whether such bottlenecks and downtime may be related to a machine condition issue, an individual's performance, foreign object detected, etc. Further, in some embodiments, the continuous monitoring may be used to update predictions for various processes within the food processing facility 100.

For example, in some embodiments, the data from the computer vision systems 175A-175H may be used to detect foreign objects that may have inadvertently been embedded within the meat on the conveyor tables 150A-150H and on the combined conveyor table 180. In some embodiments, the data from the computer vision systems 175A-175H may be used to determine a trim composition of the meat and/or whether the meat on the conveyor tables 150A-150H meets a desired trim composition. Data from the computer vision system 185 may be used, in some embodiments, to sort the meat travelling on the combined conveyor table 180 into the plurality of combos 190A-190D based on the trim composition. In some embodiments, data from the computer vision systems 215A-215C may be used to detect packaging defects and rework rates. For example, the data from the computer vision systems 215A-215C may be used to detect pockets of air, fat smears, or other problems within the vacuum sealed meat, ensure correct number/weight of products, ensure bar code on the package matches the product inside the package, etc. Data collected from the workers 160A-160H may be used to improve individual performance, determine if additional training is needed, whether stations are manned, etc. Several use cases are discussed further below.

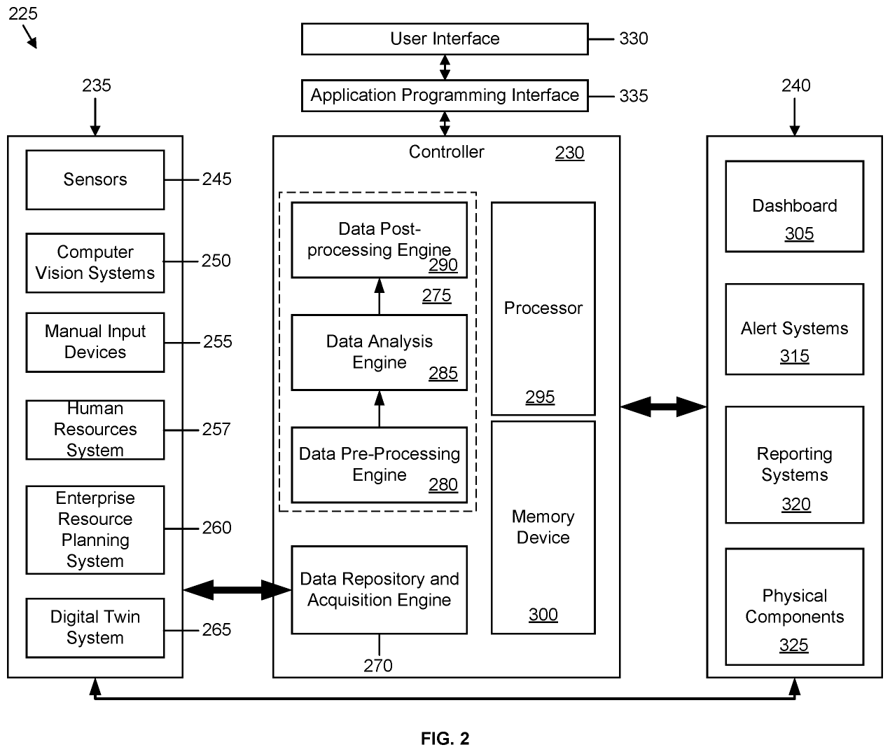

Turning now to FIG. 2, an example block diagram of a smart manufacturing system 225 for the food processing facility 100 is shown, in accordance with some embodiments of the present disclosure. In some embodiments, the smart manufacturing system 225 may be used to monitor and optimize performance of a variety of food production operations. The smart manufacturing system 225 may include a controller 230 configured to receive input data from input devices 235, analyze the input data, and provide output data to output devices 240. In some embodiments, the output data provides a real-time (or substantially real-time) feedback on various food production operations.

The smart manufacturing system 225 or at least portions thereof may be implemented in a variety of computing devices such as computers (e.g., desktop, laptop, client device, server device, etc.), tablets, personal digital assistants, mobile devices, wearable computing devices such as smart watches, other handheld or portable devices, or any other computing unit suitable for performing operations described herein. Further, in some embodiments, some or all of the features described herein may also be implemented in a cloud/distributed computing environment. Additionally, functions described herein as being performed by a computing device (e.g., the controller 230) may be performed by multiple computing devices in a distributed environment.

In some embodiments, the input devices 235 may include sensors 245 that collect a variety of data from the food processing facility 100. The sensors 245 may include the sensors 165A-165H and any other sensor devices configured to detect or measure a property, event, or change in environment in the food processing facility 100. For example, in some embodiments, the sensors 245 may include temperature sensors, pressure sensors or transducers, variable frequency drives, current transmitters, thermocouples, metal detectors, weighing scales, speed monitors, proximity sensors, position sensors, motion sensors, mass spectrometers, heat sensors, etc. In other embodiments, the sensors 245 may include additional or other types of sensors. In some embodiments, one or more of the sensors 245 may be physical sensors, while in other embodiments, one or more of the sensors may be virtual sensors. In some embodiments, the sensors 245 may be positioned in a location that is suitable to collect the type of data that a particular sensor is designed to collect.

In some embodiments, the sensors 245 may also be configured to send the collected data for use by the controller 230. In some embodiments, the sensors 245 may communicate information in addition to the collected data for use by the controller 230. For example, in some embodiments, the sensors 245 may transmit a location of a particular sensor, an identifier associated with the particular sensor, the identity of the component from which data is collected, etc. The entirety of the data that is collected and transmitted by the sensors 245 is referred to herein as “sensor data.” Further, in some embodiments, the sensors 245 may be configured to send the collected data instantaneously (or substantially instantaneously) as the data is collected. In other embodiments, the sensors 245 may be configured to buffer (e.g., store) the collected data temporarily and send the buffered data periodically. Further, in some embodiments, the sensors 245 may be configured to collect data continuously, while in other embodiments, the sensors may collect data periodically (e.g., every second, etc.). Thus, the sensors 245 may include a variety of devices configured to sense and transmit data related to a variety of conditions and positioned in a variety of suitable locations. In some embodiments, one or more of the sensors may be part of an Internet of Things device.

In some embodiments, the input devices 235 may include computer vision systems 250, such as the computer vision systems 170A-170H, 175A-175H, 185, 215A-215C, and any other computer vison system in the food processing facility 100. In some embodiments, the computer vision systems 250 may include one or more cameras configured to capture one or more images of a product, process, or workers. In other embodiments, the computer vision systems 250 may include one or more x-ray devices configured to produce and capture x-rays of a product or process. In some embodiments, the computer vision systems 250 may include other types of imaging systems such as magnetic resource imaging systems, ultrasound systems, etc. that use sound waves, magnetic fields, electromagnetic radiation, and the like. In some embodiments, the computer vision systems 250 may also include devices configured to capture video of a product, workers, or process. In some embodiments and similar to the sensors 245, the computer vision systems 250 may capture data continuously or periodically, as well as transmit data continuously or periodically for use by the controller 230. The computer vision systems 250 may transmit additional data along with the captured data. For example, in some embodiments, the computer vision systems 250 may transmit an identifier associated with the computer vision system capturing the image or video, a location of the computer vision system, settings (e.g., resolution, exposure, focal length, etc.) at which the image or video is captured, and any other information that may be needed or considered useful to have.

The input devices 235 may also include manual input devices 255. In some embodiments, data related to various products, workers, or processes may be manually input into the smart manufacturing system 225 using a variety of manual input devices such as a keyboard, stylus, touch screen, mouse, track ball, keypad, microphone, remote controllers, input ports, one or more buttons, dials, joysticks, and any other input peripheral that allows an external source, such as a user, to enter information (e.g., data) into the controller 230. The input devices 235 may also include human resources system 257 that provide data related to the workers 160A-160H and any other workers in the food processing facility 100 that are desired to be monitored. In some embodiments, the human resources system 257 may provide data that identifies an individual such as name, address, date of birth, demographic information, employee number or identifier, etc. The human resources system 257 may also provide work related data such as training levels, expertise, work hours or shifts that an individual works, any employee tracking device that a worker is associated with, stations that an individual mans, responsibilities, etc. In some embodiments, the human resources system 257 may also provide performance related data such as worker yield or output or productivity, any worker ranking, etc. In some embodiments, the human resources system 257 may provide historic, current, and predicted worker data.

In some embodiments, the input devices 235 may also include an Enterprise Resource Planning (ERP) system 260. In some embodiments, the ERP system 260 may be configured to provide production data. For example, the ERP system 260 may provide information on what food products to make (e.g., what cuts), how much food product to make, specifications of each product to be made, the type of treatments to be applied to each food product, and any other food processing and production details. In some embodiments, the ERP system 260 may supply various thresholds for the use cases discussed below. The input devices 235 may also include a Digital Twin (DT) system 265. In some embodiments, the DT system 265 may provide a simulation of the food processing facility 100, as well as insights into current food processing and production operations. In some embodiments, the DT system 265 may also provide predictions of the various food processing and production operations. For example, in some embodiments, the DT system 265 may provide predictions on labor constraints, machine constraints, opportunities for improvement, etc. In some embodiments, the DT system 265 may be continuously updated based on the data collected by the sensors 245, the computer vision systems 250, the manual input devices 255, the human resources system 257, and the ERP system 260.

Although only certain type of the input devices 235 are described herein, in other embodiments, other types of input devices providing other types of input data may be used in the smart manufacturing system 225. Generally speaking, any data that may be needed or considered useful to have in performing the functions herein may be input into the smart manufacturing system 225.

All of the input data from the input devices 235 may be sent to a data repository and acquisition engine 270 of the controller 230. In some embodiments, the data repository and acquisition engine 270 may include a supervisory control and data acquisition (SCADA) system, a programmable logic controller, or any other type of hardware, software, firmware, or combination thereof that facilitates receiving the input data from the input devices 235. In some embodiments, the data repository and acquisition engine 270 may at least temporarily store the received data, as well as supply the received data to a processing engine 275. Although shown as part of the controller 230, in some embodiments, the data repository and acquisition engine 270 may be separate from, but communicably associated with, the controller. Thus, in some embodiments, the data repository and acquisition engine 270 may serve as an intermediary between the input devices 235 and the processing engine 275.

The processing engine 275 may be configured to analyze the input data received from the data repository and acquisition engine 270. In some embodiments, the processing engine 275 may include a data pre-processing engine 280, a data analysis engine 285, and a data post-processing engine 290. Although the data pre-processing engine 280, the data analysis engine 285, and the data post-processing engine 290 are shown as separate components, in some embodiments, one or more of those engines may be integrated together into a single component and the single component may perform the operations of the individual components. The data pre-processing engine 280 may be configured to perform initial pre-processing on the data received from the data repository and acquisition engine 270. For example, the initial pre-processing may include selecting a suitable set of data from the input data received from the data repository and acquisition engine 270. In other embodiments, the initial pre-processing may include modifying the input data received from the data repository and acquisition engine 270. For example, images in image data may be cropped, rotated, color and saturation level adjusted, and/or other image processing operations performed thereon. In some embodiments, the initial pre-processing may include assigning appropriate weights to the input data received from the data repository and acquisition engine 270 for analysis by an artificial intelligence/machine learning component. In some embodiments, the pre-processing may include converting a video into static images. Thus, the data pre-processing engine 280 may perform any of a variety of pre-processing operations that may be needed or considered useful to perform on the input data prior to analysis of that input data by the data analysis engine 285. In some embodiments, no initial pre-processing of data may need to be performed. In such cases, data from the data repository and acquisition engine 270 may be directly sent to the data analysis engine 285. As used herein, “image data” may include static images, video (e.g., video stream or video images), x-ray images, other types of scan images, or any other type of static, non-static, two-dimensional, three-dimensional, or other dimensional images or stream of images.

The data analysis engine 285 may receive pre-processed data from the data pre-processing engine 280 (or from the data repository and acquisition engine 270) and perform additional processing on the input data. For example, the data analysis engine 285 may be configured to identify foreign objects in meat from image data. In some embodiments, the data analysis engine 285 may be configured to determine a trim composition of the meat from image data. In some embodiments, the data analysis engine 285 may be configured to identify air pockets or fat smears in vacuum sealed packages. Likewise, the data analysis engine 285 may be configured to analyze data to provide indications of worker performance and other food processing and production operations. In some embodiments, the data analysis engine 285 may be implemented as a machine learning or artificial intelligence engine.

When implemented as a machine learning or artificial intelligence engine, the data analysis engine 285 may be trained using training data to, for example, to classify data or identify underlying relationships in the data. In some embodiments, the data analysis engine 285 may include one or more types of suitable neural networks, including deep neural networks, convolutional neural networks, artificial neural networks, recurrent neural networks, perceptrons, or other types of machine learning algorithms. In some embodiments, the data analysis engine 285 may include other types of machine learning algorithms. In some embodiments, at least a portion of the data pre-processing engine 280 may also be configured as a machine learning algorithm.

The data post-processing engine 290 may be configured to receive processed data from the data analysis engine 285 and perform one or more post-processing operations on the processed data. For example, in some embodiments, the data post-processing engine may combine data. As another example, the data post-processing engine 290 may compare the processed data from the data analysis engine 285 with predetermined thresholds and take actions. For example, in some embodiments, the data post-processing engine 290 may raise alerts. In other embodiments, the data post-processing engine 290 may perform other types of post-processing operations. In some embodiments, no data post-processing may be needed in which case the data post-processing engine may be optional. In some embodiments, at least a portion of the data post-processing engine 290 may be configured as a machine learning algorithm.

In some embodiments, the processing engine 275 may be associated with a processor 295. The processor 295 may include one or more Central Processing Unit (“CPU”) cores or processing devices that may be configured to execute instructions associated with the data pre-processing engine 280, the data analysis engine 285, and the data post-processing engine 290. In some embodiments, the instructions and data needed to run the one or more applications may be stored within a memory device 300. The memory device 300 may also be configured to store the results of running the instructions associated with the data pre-processing engine 280, the data analysis engine 285, and the data post-processing engine 290. Although the data pre-processing engine 280, the data analysis engine 285, and the data post-processing engine 290 have been described as sharing the processor 295 and the memory device 300, in some embodiments, one or more of those engines may have separate processor(s) and/or memory(ies). In some embodiments, the data repository and acquisition engine 270 may also be associated with the processor 295 and/or the memory device 300, or have a separate processor and/or memory.

To facilitate communication between the processor 295 and the memory device 300, the memory device may include or be associated with a memory controller (not shown). In some embodiments, the memory controller may be configured as a logical block or circuitry that receives instructions from the memory device 300 and performs operations in accordance with those instructions. For example, when the execution of the data analysis engine 285 is desired, the processing engine 275 may send a request to the memory controller associated with the memory device 300. The memory controller may read the instructions associated with the data analysis engine 285 from the memory device 300, and send those instructions to the processor 295. The processor 295 may then execute those instructions by performing one or more operations called for by those instructions of the data analysis engine 285.

The memory device 300 may include one or more memory circuits that store data and instructions. The memory circuits may be any of a variety of memory types, including a variety of volatile memories, non-volatile memories, or a combination thereof. For example, in some embodiments, one or more of the memory circuits or portions thereof may include NAND flash memory cores. In other embodiments, one or more of the memory circuits or portions thereof may include NOR flash memory cores, Static Random Access Memory (SRAM) cores, Dynamic Random Access Memory (DRAM) cores, Magnetoresistive Random Access Memory (MRAM) cores, Phase Change Memory (PCM) cores, Resistive Random Access Memory (ReRAM) cores, 3D XPoint memory cores, ferroelectric random-access memory (FeRAM) cores, and other types of memory cores that are suitable for use within the memory device 300. In some embodiments, one or more of the memory circuits or portions thereof may be configured as other types of storage class memory (“SCM”). Generally speaking, the memory circuits may include any of a variety of Random Access Memory (RAM), Read-Only Memory (ROM), Programmable ROM (PROM), Erasable PROM (EPROM), Electrically EPROM (EEPROM), hard disk drives, flash drives, memory tapes, cloud memory, or any combination of primary and/or secondary memory that is suitable for performing the operations described herein.

Upon processing the input data from the input devices 235, the processing engine 275 may generate the output data that may be output to output devices 240. The output devices 240 may include a variety of output mechanisms such as external memories, printers, speakers, displays, microphones, light emitting diodes, headphones, plotters, speech generating devices, video devices, global positioning systems, and any other output peripherals that are configured to receive information (e.g., data) from the controller 230. The “data” that is either input into the controller 230 and/or output from the controller may include any of a variety of textual data, graphical data, video data, image data, sound data, position data, sensor data, combinations thereof, or other types of analog and/or digital data that is suitable for processing using the controller.

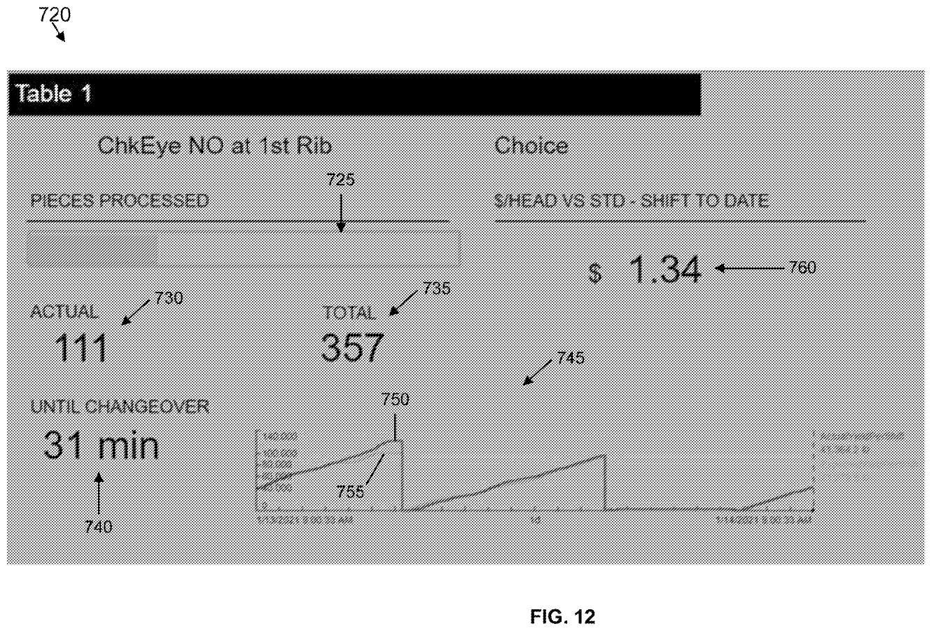

The output devices 240 may include a dashboard 305 that is configured to display a variety of information. For example, in some embodiments, the dashboard 305 may display real-time data that is collected and analyzed. In some embodiments, an instance of the dashboard 305 may be provided on each of the conveyor tables 150A-150H (as well as other conveyor tables that are being monitored). For example, in some embodiments, a dashboard may be positioned at the end of each conveyor table to provide real-time yield and productivity performance feedback directly to the workers at that conveyor table. In some embodiments, the dashboard 305 may display one or more key performance indicators such as stability factor, time to next change over, individual worker performance, make sheet details, rework rates, line speeds etc. In some embodiments, instances of the dashboard 305 may be positioned to provide managers aggregate real-time yield and productivity performance feedback of all or a group of stations. Thus, the food processing facility 100 may include a plurality of dashboards (e.g., the dashboard 310), with each dashboard displaying suitable output data. An example of a screenshot of data displayed on a dashboard is shown in FIG. 12.

In some embodiments, the output devices 240 may also include alert systems 315. For example, in some embodiments, the controller 230 may raise alerts, alarms, warnings, or other notifications. For example, in some embodiments, the controller 230 may have detected a foreign object in meat. To ensure that the meat is not packaged or shipped, the controller 230 may raise an alert or alarm notifying suitable workers of the issue. In some embodiments, the alerts, alarms, warnings, or other notifications may be sent in a variety of ways. For example, in some embodiments, the alerts, alarms, warnings, etc. may be audible notifications and/or visual notifications. In some embodiments, the alerts, alarms, warnings, etc. may additionally or alternatively include automatically sending an email, text message, phone call, or other notifications to appropriate workers. In some embodiments, the alerts, alarms, warnings, etc. may be displayed on the dashboard 305. In other embodiments, the alerts, alarms, warnings, etc. may be issued in other ways.

Further, in some embodiments, the output devices 240 may include reporting systems 320. The reporting systems 320 may include computing systems that aggregate data in desired forms to generate reports. In some embodiments, the reporting systems 320 may include information on the key performance indicators such as yield performance, stability factors, productivity performance, time to next change over, pieces processed, individual worker performance, make sheet details, rework rates, line speeds, etc. In some embodiments, based on the analysis performed in the controller 230, the controller may control various physical components in the food processing facility 100. For example, in some embodiments, based upon the determined trim composition, the controller 230 may control diverter gates on the combined conveyor table 180 to sort the meat into the plurality of combos 190A-190D based on the determined trim composition. In some embodiments, the controller 230 may stop the operation of a conveyor table. For example, if the controller 230 detects a foreign object within meat, the controller may stop the conveyor table processing that meat having the foreign object therein. Similarly, in other embodiments, based on the data analysis, the controller 230 may control operation of other physical components in the food processing facility 100.

It is to be understood that only some types of actions that the controller 230 takes upon processing the input data are described herein. In other embodiments, the controller 230 may take other or additional actions. In some embodiments, the output data may be fed back into the DT system 265 to allow the DT system to update its predictions.

Referring still to FIG. 2, in some embodiments, the controller 230 may include a user interface 330 that serves as the front end of the controller. In some embodiments, the controller 230 may be accessed through the user interface 330 via an Application Programming Interface (“API”) 335. Specifically, to access the controller 230 via the user interface 330 using the API 335, a user may use designated devices such as laptops, desktops, tablets, mobile devices, other handheld or portable devices, and/or other types of computing devices that are configured to access the API. In some embodiments, these devices may be different from the computing device on which the controller 230 is installed. In other embodiments, the controller 230 may be hosted on a cloud service and may be accessed through the cloud via a web or mobile application.

In some embodiments, the user may access the user interface 330/the controller 230 via a web browser, upon entering a uniform resource locator (“URL”) for the API 335 such as the IP address of the controller 230 or other designated web address. In some embodiments, the user interface 330/the controller 230 may be accessed via a mobile application downloaded to a mobile device. In other embodiments, the user interface 330/the controller 230 may be configured for access in other ways. Further, upon accessing the user interface 330/the controller 230, users may send instructions or queries (e.g., using the manual input devices 255) to the controller and receive information back from the controller via the user interface. Thus, the user interface 330 facilitates human-computer interaction between the users and the controller 230. In some embodiments, the user interface 330 may present a graphical user interface (“GUI”) to a user to receive input from and provide output to the user. The GUI may present a variety of graphical icons, windows, visual indicators, menus, visual widgets, and other indicia to facilitate user interaction. In other embodiments, the user interface 330 may be configured as other types of user interfaces. Further, the user interface 330 may be configured to receive user inputs in a variety of ways and present outputs/information to the users in a variety of ways.

Further, in some embodiments, the API 335 that is used to communicate with the controller 230 via the user interface 330 may be a representational state transfer (“REST”) type of API. In other embodiments, the API 335 may be any other type of web or other type of API (e.g., ASP.NET) built using any of a variety of technologies, such as Java, .Net, etc., that is suitable for facilitating communication between the controller 230 and the users via the user interface 330. In some embodiments, the API 335 may be configured to facilitate communication via a hypertext transfer protocol (“HTTP”) or hypertext transfer protocol secure (“HTTPS”) type request. The API 335 may receive an HTTP/HTTPS request and send an HTTP/HTTPS response back. In other embodiments, the API 335 may be configured to facilitate communication using other or additional types of communication protocols.

It is to be understood that only some components of the smart manufacturing system 225 are shown and described in FIG. 2. However, the smart manufacturing system 225, including the controller 230, may include or be associated with any of a variety of hardware, software, and/or firmware components that are needed or considered desirable in performing the functions described herein. Generally speaking, the smart manufacturing system 225 may include any of a variety of hardware, software, and/or firmware components that are needed or considered desirable in performing the functions described herein.

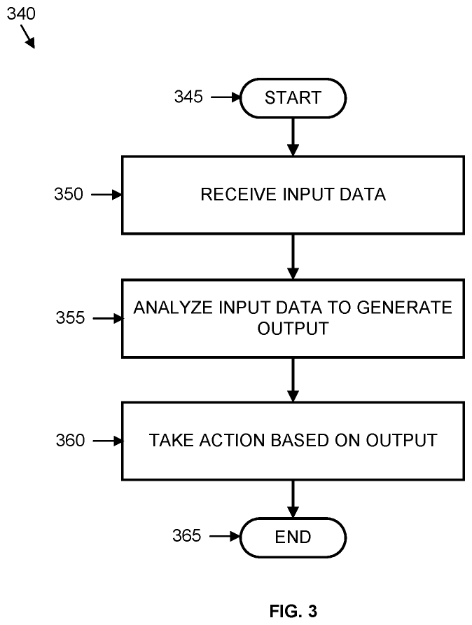

Turning to FIG. 3, an example flowchart outlining operations of a process 340 is shown, in accordance with some embodiments of the present disclosure. The process 340 may be implemented by the controller 230 for controlling various production operations in the food processing facility 100. Thus, upon starting at operation 345, the controller 230 receives input data from one or more of the input devices 235 at operation 350. For example, in some embodiments, the controller 230 may receive input data from one or more of the computer vision systems 170A-170H, 175A-175H, 185, 215A-215C. In some embodiments, the controller 230 may receive sensor data from the sensors 165A-165H. In other embodiments, the controller 230 may receive input data (e.g., workers data) from the human resources system 257, the ERP system 260, the DT system 265, the manual input devices 255, or any other type of input data. In some embodiments, the controller 230 may store the input data within the data repository and acquisition engine 270.

At operation 355, the controller 230 analyzes the input data received at the operation 350. In some embodiments, the controller 230 may be configured to detect and identify a variety of conditions. For example, in some embodiments, the controller 230 may be configured to detect foreign objects in meat. In other embodiments, the controller 230 may be configured to identify a trim composition (e.g., fat to lean ratio) of the meat. In some embodiments, the controller 230 may be configured to sort the meat based upon the identified trim composition. In some embodiments, the controller 230 may be configured to detect voids (e.g., air), fat smears, or other defects within a vacuum sealed package. In yet other embodiments, the controller 230 may be configured to detect rework rates and yield performance. Yield performance may include analyzing waste streams and determining how much, if any, meat is being wasted. Yield performance may include determining how much meat is being processed per station in a predetermined time period. Yield performance may include productivity levels of workers and any other metric that may provide performance related data associated with the meat or the workers. Rework rates may include a number of vacuum sealed packages per unit time exiting the vacuum packaging stations 200A-200J that have some defects and need to be repackaged. In other embodiments, the controller 230 may perform other types of analysis on the input data.

In some embodiments, the controller 230 may perform one or more pre-processing operations on the input data, as discussed above. In some embodiments, the controller 230 may also perform one or more post-processing operations on the analyzed data, as also discussed above. Thus, in some embodiments, the input data may be pre-processed, analyzed, and post-processed to generate an output. Based on the output, the controller 230 takes one or more actions at operation 360. For example, in some embodiments, the one or more actions may include raising alerts or warnings. In other embodiments, the one or more actions may include stopping a conveyor table, activating diverter valves or gates, updating real-time feedback data on dashboards, generating and/or updating key performance indicators, sending data to the DT system 265 for updating predictions, etc. Various specific use cases are discussed below. The process 340 ends at operation 365.

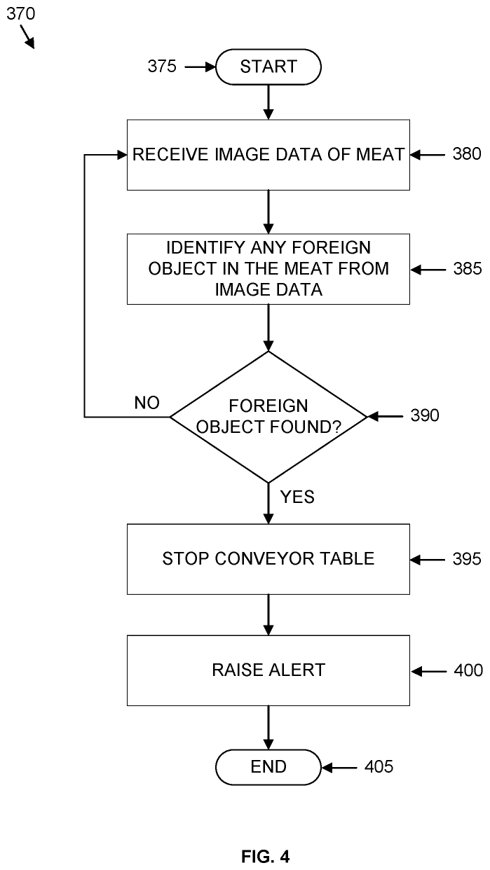

Referring to FIG. 4, an example flowchart outlining operations of a process 370 is shown, In accordance with some embodiments of the present disclosure. The process 370 may be performed by the controller 230 for detecting foreign objects in meat. The process 370 may include other or additional operations depending upon the particular embodiment. Thus, upon starting at operation 375, the controller 230 receives input data. In some embodiments, to detect foreign objects in meat, the controller 230 receives image data of the meat. In some embodiments, the image data may include images and/or video. In other embodiments, the image data may include other types of image data, as discussed above. In some embodiments, the image data may include X-ray images to identify high density foreign objects like bone and metal. Thus, in some embodiments, the type of images that are captured may depend upon the type of foreign objects that are desired to be detected.

In some embodiments, the image data may have been captured by one or more of the computer vision systems 250. For example, in some embodiments, it may be desirable to detect foreign objects in meat on the conveyor tables 150A-150H before that meat is further processed and/or packaged. Thus, in some embodiments, the controller 230 may receive image data captured by the computer vision systems 175A-175H. The description below is with respect to the computer vision system 175A capturing image data from the conveyor table 150A. However, the description below is equally applicable to the computer vision systems 175B-175H capturing data from the conveyor tables 150B-150H or to any other conveyor tables where meat needs to be monitored for foreign objects.

In some embodiments, the computer vision system 175A may capture image data from each piece of meat that exits the conveyor table 150A and onto the combined conveyor table 180. By capturing image data of meat transferring from the conveyor table 150A to the combined conveyor table 180, the computer vision system 175A may be able to capture image data from various angles of the meat, thereby allowing detection of foreign objects that may be embedded within or on surfaces that may not be readily visible. In some embodiments, the computer vision system 175A may capture a single image (and/or video) of each piece of meat. In other embodiments, the computer vision system 175A may capture multiple images (and/or videos) of each piece of meat. In some embodiments, the conveyor table 150A may be configured to move at a designated rate. Based on the rate of movement of the conveyor table 150A, the computer vision system 175A may be configured to capture images (and/or videos) at a pre-determined rate that allows the computer vision system to capture clear and complete image(s) (and/or videos) of each piece of meat exiting the conveyor table.

At operation 385, the controller 230 identifies any foreign object in each piece of meat exiting the conveyor table 150A. In some embodiments, the controller 230, and particularly the data pre-processing engine 280 of the controller, may pre-process the image data. For example, in some embodiments, if multiple images (and/or videos) are captured for each piece of meat, the controller 230 may select an appropriate image (and/or video) for analysis (e.g., an image and/or video that shows a certain angle of the meat, shows a certain surface of the meat, etc.), combine multiple images (and/or videos) to obtain a suitable image and/or video (e.g., if none of the images are entirely suitable, the controller may stitch together multiple images to obtain a suitable image), modify images and/or videos (e.g., enhance the images to facilitate better analysis), convert video into static images, etc. In some embodiments, no pre-processing of the images (and/or videos) may be needed. Upon pre-processing (or if no pre-processing is used), the selected image data may be analyzed by the data analysis engine 285 of the controller 230. In some embodiments, the data analysis engine 285 may be previously trained to identify foreign objects.

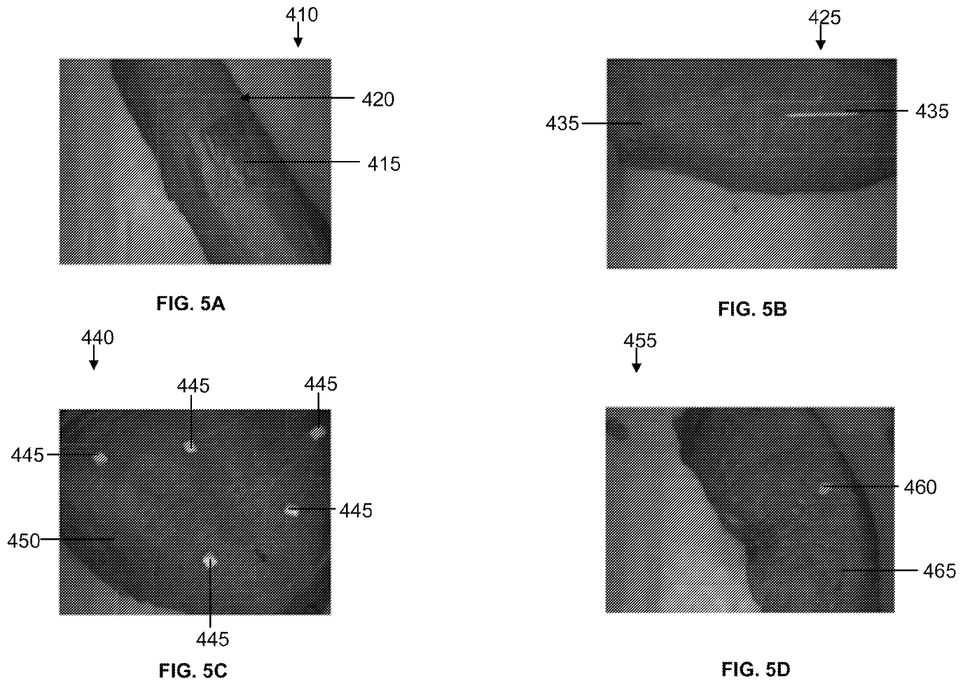

For example, in some embodiments, the data analysis engine 285 may be trained previously to identify wood pieces, gloves, candy wrappers, plastic, etc. in the meat. In some embodiments, the data analysis engine 285 may be trained to identify the foreign objects based on variations in texture and/or color. Specifically, the texture and/or color of the foreign objects may be different than the texture and/or color of the surrounding meat. By training the data analysis engine 285 to identify texture and/or color variations, the data analysis engine may be configured to detect foreign objects. Example images showing various foreign objects are shown in FIGS. 5A-5D. In some embodiments, the data analysis engine 285 may be trained using a deep reinforcement learning method in which for every accurate detection of a foreign object, the data analysis engine may receive a reward with the goal of maximizing the reward. In other embodiments, the data analysis engine 285 may be trained using other techniques.

Thus, upon training the data analysis engine 285 for detecting specific types of foreign objects, the image data from the operation 380 (or the image data that has been pre-processed) may be input into the data analysis engine. The data analysis engine may identify any foreign objects in that image data. At operation 390, the controller 230 determines if any foreign object is found in the meat. If yes, then at operation 395, the controller 230 stops the conveyor table 150A and raises an alert at operation 400. The conveyor table 150A may be stopped by activating a break or stop button associated with the conveyor table 150A. By stopping the conveyor table 150A (and possibly the combined conveyor table 180 on which the meat with the foreign object may have exited to), the controller 230 may ensure that the meat having the foreign object therein is not packaged or further processed. Further, there may be a possibility that other meat on the conveyor table 150A may also have similar foreign objects. By stopping the conveyor table 150A, the source of the foreign object may be timely identified and removed.

By raising alerts, the controller 230 may warn managers, the workers 160A at the conveyor table 150A, or other stakeholders of the presence of the foreign object. In some embodiments, an alert may be displayed on a dashboard associated with the conveyor table 150A (e.g., a dashboard positioned at the end of the conveyor table). The controller 230 may take other actions as well. The process 370 ends at operation 405.

Turning to FIGS. 5A-5D, example images showing foreign objects therein are shown, in accordance with some embodiments of the present disclosure. FIG. 5A shows an example image 410 having a piece of plastic 415 in a piece of meat 420. FIG. 5B shows an example image 425 having a wood sliver 430 in a piece of meat 435. FIG. 5C shows an example image 440 having a plurality of wood pellets 445 in a piece of meat 450. FIG. 5D shows an example image 455 having another piece of plastic 460 in a piece of meat 465. As can be seen from the example images 410, 425, 440, 455, the color and/or texture of the plastic 415, the wood sliver 430, the plurality of wood pellets 445, and the plastic 460, respectively, varies from the respective surrounding piece of meat 420, 435, 450, 465. By identifying such variations in texture and/or color, the foreign objects may be identified.

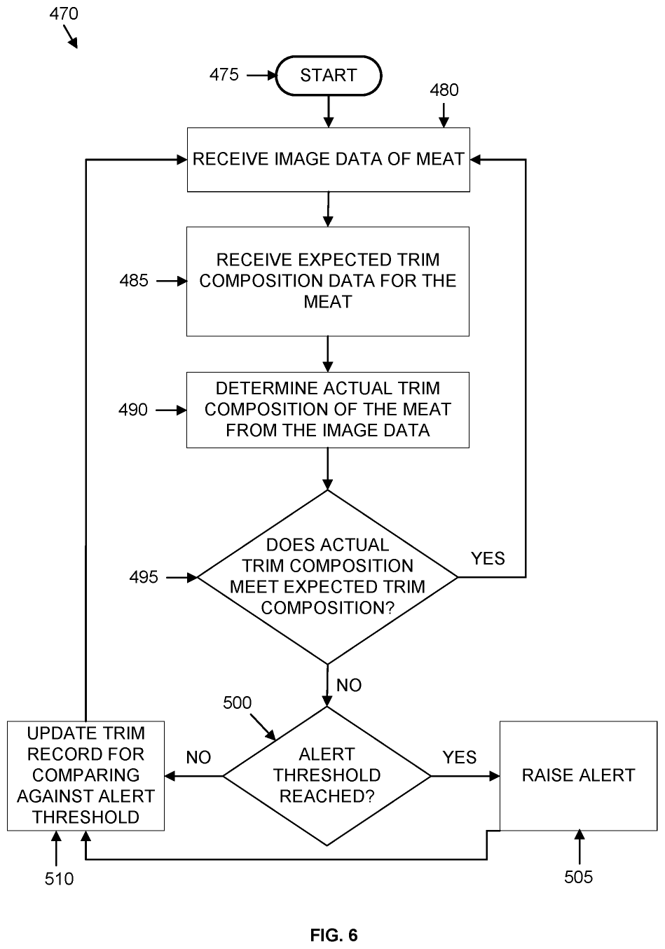

Referring to FIG. 6, an example flowchart outlining operations of a process 470 is shown, In accordance with some embodiments of the present disclosure. The process 470 may be performed by the controller 230 for determining a trim composition of meat in real-time and providing real-time feedback based on the determined trim composition. The process 470 may include other or additional operations depending upon the particular embodiment. In some embodiments, each of the stations 145 may be configured to produce meat having a particular lean point. Lean point may be defined in terms of a ratio of fat content to lean content (or lean content to fat content). The workers 160A-160H at the conveyor tables 150A-150H may be trained to trim meat to achieve the desired lean point (e.g., the lean to fat ratio) designated for that conveyor table. The controller 230 may be configured to monitor the lean point of meat on each of the conveyor tables 150A-150H and track the yield from those conveyor tables. If the lean point from a particular one of the conveyor tables 150A-150H changes from the desired lean point, an alert may be raised, thereby ensuring a consistent desired lean point.

Thus, upon starting at operation 475, the controller 230 receives image data of meat at operation 480. The description below is with respect to the computer vision system 175A capturing image data from the conveyor table 150A. However, the description below is equally applicable to the computer vision systems 175B-175H capturing data from the conveyor tables 150B-150H. Thus, at the operation 480, the controller 230 receives the image data of a piece of meat exiting the conveyor table 150A. In some embodiments, the image data may include image(s) and/or video(s) of the meat. In other embodiments, the image data may include other types of image data as described above. Further, the image data may be captured at various angles and positons as desired. At operation 485, the controller 230 may receive the expected or desired trim composition of the meat being processed on the conveyor table 150A. In some embodiments, the controller 230 may receive the expected trim composition from the ERP system 260. In other embodiments, the controller 230 may receive the expected trim composition from other sources. In some embodiments, the controller 230 may receive and save the expected trim composition before the start of the process 470 in which case the operation 485 may be skipped.

At operation 490, the controller 230 determines the actual trim composition of the meat whose image data is received at the operation 480. In some embodiments, the controller 230, and particularly the data pre-processing engine 280 of the controller, may pre-process the image data. For example, in some embodiments, if multiple images (and/or videos) are captured for each piece of meat, the controller 230 may select an appropriate image (and/or video) for analysis (e.g., an image and/or video that shows a certain angle of the meat, shows a certain surface of the meat, etc.), combine multiple images (and/or videos) to obtain a suitable image and/or video (e.g., if none of the images are entirely suitable, the controller may stitch together multiple images to obtain a suitable image), modify images and/or videos (e.g., enhance the images to facilitate better analysis), convert video into static images, etc. In some embodiments, no pre-processing of the images (and/or videos) may be needed. Upon pre-processing (or if no pre-processing is used), the selected image data may be analyzed by the data analysis engine 285 of the controller 230. In some embodiments, the data analysis engine 285 may be previously trained to determine the actual trim composition.

In some embodiments, the controller 230 may determine the actual trim composition by identifying a percentage of area of the meat that is lean versus the percentage of area of the meat that is fat. In some embodiments, the controller 230 may identify the percentage of area that is lean or fat by identifying variations in texture and/or color. In some embodiments, the area of the meat that is lean may have a different texture and/or color than the area of the meat that is fat. Thus, by identifying variations in texture and/or color, the controller 230 may determine individual areas (e.g., in square inches, etc.) that appear to be lean versus fat. In some embodiments, the controller 230 may be aware of the depth of the meat to compute the individual areas of lean versus fat. In other embodiments, the depth of the meat on the conveyor table 150A may be considered minimal and the controller 230 may ignore the depth of the meat in computing the individual areas of the lean versus fat. In some embodiments, the weight of the meat may be measured and/or the speed of the conveyor table 150A may be determined to facilitate computing the individual areas of fat versus lean. The controller 230 may then sum all the individual areas of lean and all the individual areas of fat to obtain the total percentage of area that is lean versus area that is fat. The controller 230 may convert the percentage of lean to fat area to a ratio to obtain the lean point. The controller 230, and particularly the data analysis engine 285 of the controller, may be trained to identify the variations in texture and/or color, as discussed above in FIG. 4.

Upon computing the actual trim composition of the meat at the operation 490, at operation 495, the controller 230 compares the actual trim composition of the meat with the expected trim composition received at the operation 485. If the actual trim composition of the meat satisfies the expected trim composition, the process 470 loops back to the operation 480 to continue analyzing the next piece of meat at the conveyor table 150A. In some embodiments, the actual trim composition may satisfy the expected trim composition if the actual and expected trim compositions are same or the variation is within a predetermined threshold. If the actual trim composition does not satisfy the expected trim composition at the operation 495, at operation 500 the controller 230 determines if an alert should be raised. Specifically, in some embodiments, the controller 230 may be configured to raise an alert each time the actual trim composition does not satisfy the expected trim composition. In other embodiments, the controller 230 may be configured to raise an alert if the actual trim composition continually does not satisfy the expected trim composition. For example, if the expected trim composition is 50:50 (e.g., 50% lean content and 50% fat content) and the controller 230 determines that the trim composition has continually changed to something else (e.g., 60:40), then the controller may raise an alert. In some embodiments, the controller 230 may be pre-programmed with an alert threshold.

The alert threshold may indicate when to raise an alert. For example, the alert threshold may indicate that an alert is to be raised each time the actual trim composition does not satisfy the expected trim composition. In other embodiments, the alert threshold may indicate that an alert is to be raised if a predetermined number of meat pieces in a predetermined time period have actual trim composition that do not satisfy the expected trim composition. For example, in some embodiments, if the controller 230 identifies X number of pieces of meat that violate the expected trim composition in a Y amount of time, the controller may raise an alert. Thus, at the operation 500, the controller 230 determines if the alert threshold is reached. In some embodiments, the controller 230 may store a trim record on the number of pieces of meat that violate the expected trim composition in a given time period to compare against the alert threshold.

At the operation 500, the controller 230 compares the trim record against the alert threshold. If the alert threshold is reached, at operation 505 the controller 230 raises an alert. In some embodiments, the alert may be a visual alert displaying on a dashboard of the conveyor table 150A that the trim composition has changed. The alert may be an indication to the workers 160A to adjust the trimming of the meat. Other types of visual, audible, or other alerts may be raised as well. In some embodiments, the controller 230 may take other actions as well. For example, in some embodiments, the controller 230 may stop the conveyor table 150A for further inspection, worker training, etc. In some embodiments, upon raising the alert, the controller 230 may reset the trim record. Upon raising the alert, or if the alert threshold is not reached, the controller updates the trim record at operation 510. The update may be to update a counter that tracks a number of pieces of meat that have violated the expected trim composition in a predetermined time period. Upon updating the trim record, the process 470 loops back to the operation 480 to continue determining the trim composition.

Thus, the process 470 continually monitors the actual trim composition of the meat from each conveyor table to ensure a consistent lean point.

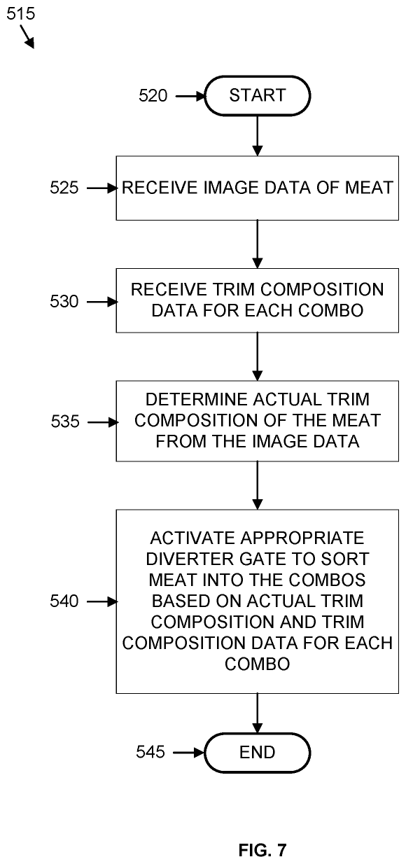

Referring now to FIG. 7, an example flowchart outlining operations of a process 515 is shown, In accordance with some embodiments of the present disclosure. The process 515 may be performed by the controller 230 for sorting meat based on a determined actual trim composition. The process 515 may include other or additional operations depending upon the particular embodiment. As discussed above, in some embodiments, the meat from the combined conveyor table 180 may be sorted into the plurality of combos 190A-190D. In some embodiments, each of the plurality of combos 190A-190D may be designated to hold meat of a particular trim composition. The controller 230 may facilitate the sorting of meat into the plurality of combos 190A-190D based upon a determined actual trim composition of the meat

Thus, upon starting at operation 520, the controller 230 receives image data of meat from the combined conveyor table 180. In some embodiments, the image data may be captured by the computer vision system 185. In some embodiments, the image data may include images and/or videos of the meat. In other embodiments, the image data may include other types of image data described above. At operation 530, the controller 230 receives the trim composition data for each of the plurality of combos 190A-190D into which the meat from the combined conveyor table 180 is to be sorted. In some embodiments, the combo 190A may be configured to receive meat having a high lean content, the combo 190B may be configured to receive meat having a medium high lean content, the combo 190C may be configured to receive meat having a medium low lean content, and the combo 190D may be configured to receive meat having a low lean content. In some embodiments, the lean content (e.g. lean point) associated with high lean, medium high lean, medium low lean, and low lean may be pre-determined. In other embodiments, greater than or fewer than four combos configured to receive meat of other trim compositions may be used. In some embodiments, the operation 530 may be performed prior to starting the process 515 in which case the operation 530 may be skipped.

At operation 535, the controller 232 determines the actual trim composition of the meat as discussed above at operation 490 of FIG. 6. Based upon the determined actual trim composition, the controller 230 may automatically sort the meat into one of the plurality of combos 190A-190D. Specifically at operation 540, the controller 230 activates an appropriate diverter gate on the combined conveyor table 180 to divert the meat to the appropriate one of the plurality of combos 190A-190D. For example, if the controller 230 determines that the meat has a trim composition that corresponds to a high lean content, the controller may activate the diverter gate on the combined conveyor table 180 to divert the meat to go into the combo 190A that is configured to receive meat having a high lean content.

The controller 230 may similarly sort each piece of meat on the combined conveyor table 180. By automatically sorting meat into appropriate combos, the present disclosure insures a consistent lean point in each of the combos 190A-190D, thereby avoiding need for manually inspecting and sorting meat into those combos. The process 515 ends at operation 545.

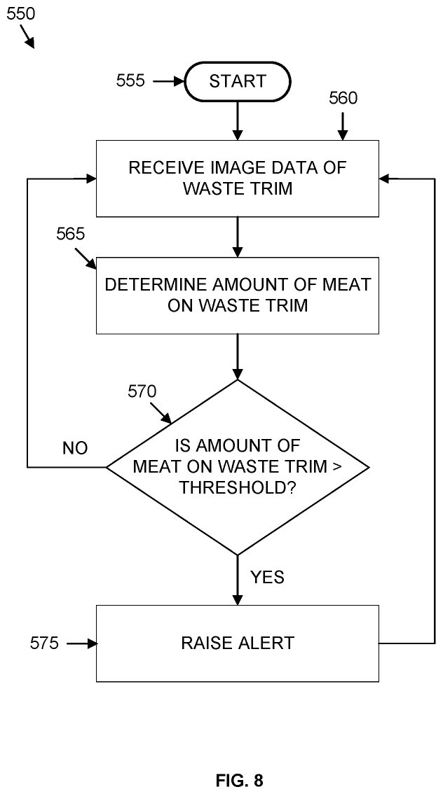

Turning now to FIG. 8, an example flowchart outlining operations of a process 550 is shown, In accordance with some embodiments of the present disclosure. The process 550 may be performed by the controller 230 for monitoring waste trim and providing real-time feedback on whether meat is being wasted and allowing workers to make self-adjustments on trimming the meat to minimize meat wastage. The process 550 may include other or additional operations depending upon the particular embodiment. In some embodiments, the food processing facility 100 may include waste stream conveyor tables that carry waste trim that is left over after meat is trimmed and processed (e.g., as shown by the arrows 225 in FIG. 1). The waste trim may include meat trimmings and bone. This waste trim may be continuously monitored for the amount of meat that may not have been removed, and therefore, wasted. The controller 230 may be configured to determine such wastage of meat by monitoring the waste trim on the waste stream conveyor tables. Thus, upon starting at operation 555, the controller 230 receives image data of waste product from a waste stream conveyor table. Again, in some embodiments, the image data may include images and/or videos. In other embodiments, the image data may include other types of image data discussed above.

At operation 565, the controller determines the amount of meat from the image data received at the operation 560. In some embodiments, the controller 230, and particularly the data pre-processing engine 280 of the controller, may pre-process the image data. For example, in some embodiments, if multiple images (and/or videos) are captured for each piece of meat, the controller 230 may select an appropriate image (and/or video) for analysis (e.g., an image and/or video that shows a certain angle of the meat, shows a certain surface of the meat, etc.), combine multiple images (and/or videos) to obtain a suitable image and/or video (e.g., if none of the images are entirely suitable, the controller may stitch together multiple images to obtain a suitable image), modify images and/or videos (e.g., enhance the images to facilitate better analysis), convert video into static images, etc. In some embodiments, no pre-processing of the images (and/or videos) may be needed. Upon pre-processing (or if no pre-processing is used), the selected image data may be analyzed by the data analysis engine 285 of the controller 230. In some embodiments, the data analysis engine 285 may be previously trained to analyze waste trim based on variations in texture and/or color.

In some embodiments, the controller 230 may determine the amount of meat on the waste product by identifying variations in texture and/or color. For example, the meat may have a different texture and/or color than the bone. Thus, in some embodiments, the controller 230 may also be configured to identify a percentage of area of the waste trim that is meat versus bone. In some embodiments, the controller 230 may identify variations in texture and/or color, as well as percentage of area as discussed above. At operation 570, the controller 230 determines if the amount of meat on the waste trim exceeds a predetermined threshold indicating the amount of meat on the waste trim that is acceptable. In some embodiments, the controller 230 may have received the threshold from the ERP system 260. In other embodiments, the controller 230 may receive the threshold from other sources. If the controller 230 determines that the amount of meat in the waste trim exceeds the threshold, at operation 575 the controller raises an alert. In some embodiments, the alert may be a visual alert displaying a notification on a dashboard associated with the waste stream conveyor table. In other embodiments, the alert may be an audible alert or other types of notifications. The alert provides real time feedback to workers manning the waste stream conveyor table to make self adjustments in trimming the meat product to minimize meat wastage. The process 550 then loops back to the operation 560 to continue monitoring the waste trim from the waste stream conveyor table. On the other hand, if at the operation 570 the controller determines if the amount of meat on the waste trim is less than or equal to the threshold, the controller simply continues monitoring the waste product by looping back to the operation 560.

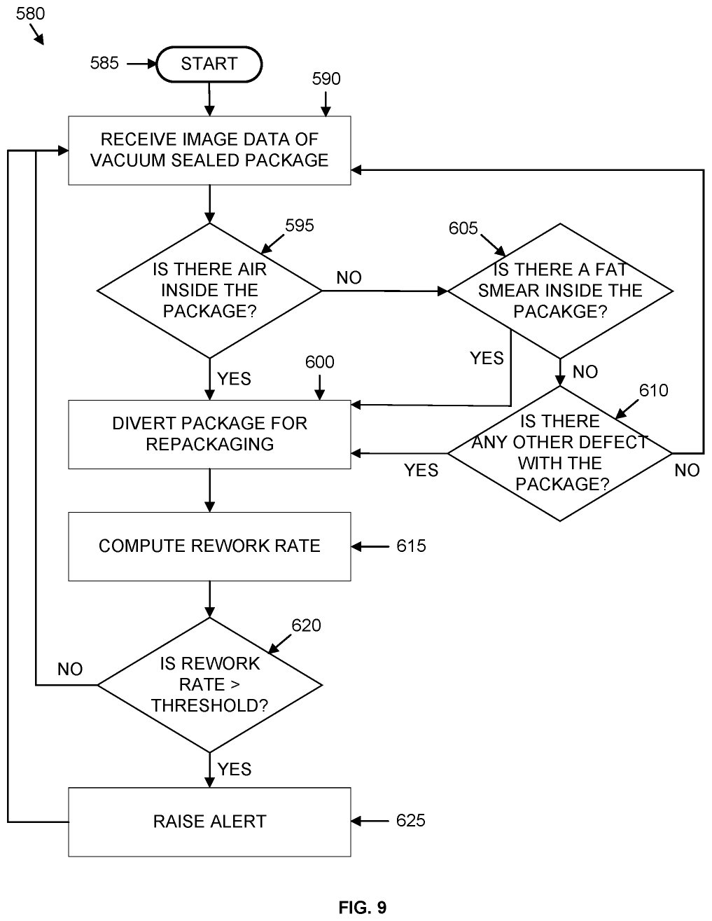

Turning now to FIG. 9, an example flowchart outlining operations of a process 580 is shown, In accordance with some embodiments of the present disclosure. The process 580 may be performed by the controller 230 for monitoring vacuum sealed packages and providing real-time feedback on whether the packages have air pockets or voids, fat smears, or any other defects. The process 580 may include other or additional operations depending upon the particular embodiment. As discussed above, meat from the conveyor tables 150A-150H may go into the vacuum packaging stations 200A-200J and vacuum sealed packages come out onto the conveyor tables 205A-205C. Those vacuum sealed packages may be continuously monitored for any defects. Defective vacuum sealed packages may be diverted for repackaging, thereby avoiding defective vacuum packed packages from being shipped out and avoiding (or at least minimizing) the need for manual inspection.

Further, in some embodiments, the defects in the vacuum sealed packages may be indicative of other problems. For example, in some embodiments, the defects in the vacuum sealed packages may be introduced due to mechanical issues with the vacuuming machines that evacuate air from and seal the meat, using wrong type of packing material, loading the meat into the vacuum packaging stations 200A-200J incorrectly, etc. By monitoring and identifying defects in the vacuum sealed packages, the packaging operation may be stopped for inspection and fixing the problem causing the defective vacuum sealed packages. Additionally, in some embodiments, the controller 230 may be configured to track rework rates (e.g., number of packages diverted per unit of time) of the vacuum sealed packages that are diverted for repackaging. A real-time feedback of the rework rate may be continuously provided to allow for recommendations or adjustments if the rework rates exceed a threshold.

Thus, upon starting at operation 585, the controller 230 receives image data from a vacuum sealed package at operation 590. The image data may be collected by computer vision systems 215A-215C. In some embodiments, the image data may include images, videos, and/or x-ray images. In other embodiments, the image data may include other types of image data discussed above. The description below is with respect to the data gathered by the computer vision system 215A on the conveyor table 205A. However, the description below is similarly applicable to the computer vision systems 215B-215C on the conveyor tables 205B-205C respectively. At operation 595, the controller 230 determines if there air or void inside the vacuum sealed package. In some embodiments, the controller 230, and particularly the data pre-processing engine 280 of the controller, may pre-process the image data. For example, in some embodiments, if multiple images (and/or videos) are captured for each piece of meat, the controller 230 may select an appropriate image (and/or video) for analysis (e.g., an image and/or video that shows a certain angle of the meat, shows a certain surface of the meat, etc.), combine multiple images (and/or videos) to obtain a suitable image and/or video (e.g., if none of the images are entirely suitable, the controller may stitch together multiple images to obtain a suitable image), modify images and/or videos (e.g., enhance the images to facilitate better analysis), convert video into static images, etc. In some embodiments, no pre-processing of the images (and/or videos) may be needed. Upon pre-processing (or if no pre-processing is used), the selected image data may be analyzed by the data analysis engine 285 of the controller 230. In some embodiments, the data analysis engine 285 may be previously trained to identify voids in the vacuum sealed package.

In some embodiments, the computer vision system 215A may include a mass spectrometer that provides a mass spectrometer image. From the mass spectrometer image, the controller 230 may identify any residual gas or oxygen in the vacuum sealed package. For example, in some embodiments, the controller 230 may determine an outer boundary of the packaging material of the vacuum sealed package and an outer boundary of the meat inside the packaging material. If the outer boundary of the packaging material and the outer boundary of the meat inside the packaging material do not match or have a gap that is greater that a pre-determined threshold, the controller 230 may determine that a void exists in the vacuum sealed package. In other embodiments, the image data may include other types of images that allow the controller 230 to determine the presence of air or gap in the vacuum sealed package.

If the controller 230 identifies air inside the vacuum packed meat package, then at operation 600 the controller diverts the vacuum packed meat package for re-packaging. In some embodiments, the controller 230 may divert the vacuum packed meat package for re-packaging by activating a diverter gate that diverts the vacuum packed meat package to a re-packaging conveyor table. On the other hand, if the controller 230 determines that there is no air inside the vacuum sealed package, then at operation 605 the controller determines if there is a fat smear inside the vacuum packed meat package. To detect fat smears from the image data of the operation 590, the controller 230 may identify variations in texture and/or color in the image data. In general, the texture and/or color of the fat smear may be different from the texture and/color of the surrounding area. By identifying variations in texture and/or color, the controller 230 may detect fat smears. In some embodiments, the controller 230 may have been previously trained to identify fat smears.

If the controller detects a fat smear, the process 580 loops back to the operation 600 where the vacuum sealed package is diverted for re-packaging. If the controller 230 detects no fat smear at the operation 605, the controller determines if there are other defects with the vacuum sealed package at operation 610. For example, the controller 230 may determine if the vacuum sealed package has been damaged in any way. As another example, the controller 230 may determine a weight of the vacuum sealed package. In some embodiments, the controller 230 may receive weight data of the vacuum packed meat package from the conveyor table 205A. Similarly, the controller 230 may detect other defects in the vacuum sealed package. If the controller 230 finds any defects in the vacuum sealed package, the controller diverts the vacuum sealed package for re-packaging at the operation 600. Otherwise, the process 580 goes back to the operation 590 to analyze the next vacuum sealed package.

Further, in addition to diverting the vacuum sealed package for re-packaging at the operation 600, the controller 230 also determines a rework rate at operation 615. In some embodiments, the rework rate may correspond to the number of vacuum packed meat packages diverted for re-packaging every pre-determined unit of time. In some embodiments, the controller 230 may compute the rework rate by dividing the total number of packages rejected by the total number of packages processed in a given unit of time. In other embodiments, the controller 230 may compute the rework rate in other ways. At operation 620, the controller 230 compares the computed rework rate of the operation 615 with a threshold rework rate. In some embodiments, the controller 230 may receive the threshold rework rate from the ERP system 260. In other embodiments, the controller 230 may receive the threshold rework rate from other sources. If the controller 230 determines the computed rework rate from the operation 615 is greater than the threshold rework rate, the controller raises an alert at operation 625. In some embodiments, the alert may provide a real-time feedback on the rework rate on a dashboard to packaging machine operators. The packaging machine operators may use the rework rate to make recommendations for adjustments or repairs to improve the rework rate such that fewer number of vacuum packed meat packages are diverted for re-packaging. In some embodiments, the controller 230 may send alerts to other stakeholders and/or the controller may take other types of actions. On the other hand, if the rework rate computed at the operation 615 is less than or equal to the threshold rework rate then no alerts may be needed and the controller 230 may continue monitoring image data of vacuum sealed package at the operation 590.

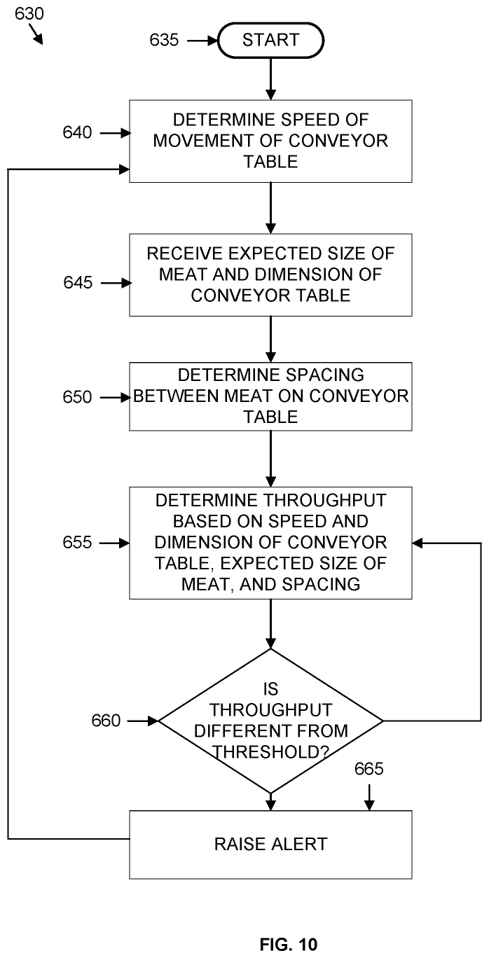

Turning now to FIG. 10, an example flowchart outlining operations of a process 630 is shown, In accordance with some embodiments of the present disclosure. The process 630 may be performed by the controller 230 for identifying and providing real-time feedback on bottlenecks and downtime. The process 630 may include other or additional operations depending upon the particular embodiment. Thus, upon starting at operation 635, the controller 230 determines a speed of movement of a conveyor table. For purposes of explanation, FIG. 10 is described with respect to the conveyor table 150A. However, the process 630 may be applicable to any conveyor table in the food processing facility 100 where it is desirable to identify and provide feed-back on bottlenecks and downtimes.

In some embodiments, the speed of the conveyor table 150A may be monitored by the sensors 165A associated with the conveyor table. In some embodiments, the speed of the conveyor table 150A may be monitored by the computer vision system 175A. In some embodiments, the computer vision system 175A may capture video of the conveyor table 150A as that conveyor table is moving. In some embodiments, the controller 230 may use the captured video to determine the speed of the conveyor table 150A. For example, in some embodiments, the controller 230 may establish one or more boundaries of known distances between two points or sections of the conveyor table. The controller 230 may then be configured to identify the one or more boundaries from the video and measure the time from the video that the conveyor table takes to pass between those one or more boundaries. Based on the known distance between the one or more boundaries and the time taken by the conveyor table 150A to pass across those one or more boundaries, the controller 230 may determine the speed of the conveyor table by dividing the known distance by time (Distance/Time=Speed). In other embodiments, the controller 230 may determine the speed of the conveyor table 150A in other ways. For example, in some embodiments, the conveyor table 150A may be configured to move at a designated speed. Thus, in some embodiments, the controller 230 may receive the designated speed of the conveyor table 150A from the ERP system 260 or from other sources.

At operation 645, the controller 230 may also receive the dimensions of the conveyor table 150A. For example, in some embodiments, the controller 230 may receive the total operable length of the conveyor table 150A. The operable length of the conveyor table 150A may be the total length of the top surface of the conveyor table on which the meat is processed. In some embodiments, each conveyor table may be of a predetermined length. Thus, in some embodiments, the controller 230 may receive the length of the conveyor table 150A from the ERP system 260 or from other sources. In some embodiments, the controller 230 may also receive the width of the conveyor table 150A. Similar to the length, the width of the conveyor table 150A may be the width of the top surface of the conveyor table on which the meat is processed. Also, similar to the length, in some embodiments, the controller 230 may receive the width of the conveyor table 150A from the ERP system 260 or from other sources. In other embodiments, the controller 230 may receive other dimensions of the conveyor table 150A that may be considered suitable.

At the operation 645, the controller 230 may also receive an expected size of each piece of meat that is to be processed on the conveyor table 150A. As discussed above, each conveyor table in the food processing facility 100 may be configured for a specific purpose. For example, for the conveyor tables that process meat, the specifications of the processing (e.g., the size in which the meat is to be trimmed, the lean point that is desired, etc.) may be known. This, in some embodiments, the controller 230 may receive the size of the meat being processed on the conveyor table 150A from the ERP system 260 or from other sources. Although the process 630 is described with respect to meat processing, it is to be understood that the process 630 may be used for determining bottlenecks and downtimes on other conveyor tables too that do not necessarily process meat. For example, the process 630 may also be used for the conveyor tables 205A-205C that handle packaging.

In some embodiments, the controller 230 may also receive a spacing between meat on the conveyor table 150A. Thus, at operation 650, the controller 230 receives image data (e.g., images, videos, etc.) from the computer vision system 175A or another computer vision system configured to capture such spacing data from the conveyor table 150A. The controller 230 may then determine an actual spacing between the meat based on the image data. For example, in some embodiments, the controller 230 may measure the distance between each pair of meat located adjacent to each other on the conveyor table 150A and average the distances to obtain an average spacing. In other embodiments, the controller 230 may determine the spacing in other ways.

At operation 655, the controller 230 determines an actual throughout based on the data collected/determined at the operations 640-650. For example, in some embodiments, the controller 230 may count the number of pieces that pass through the view of the computer vision system 175A every unit of time (e.g., one minute) to determine the actual throughput. In other embodiments, the controller 230 may determine the actual throughput in other ways. At operation 660, the controller 230 compares the actual throughout with a threshold throughput. The threshold throughput may correspond to a throughout at which the conveyor table is processing meat optimally (e.g., an appropriate number of meat pieces are being processed in a given unit of time). In some embodiments, the controller 230 may receive the threshold throughout from the ERP system 260 of from other sources. If the controller 230 determines that the actual throughput is different from the threshold throughput, that may be indicative of a bottleneck. For example, if the actual throughput is greater than the threshold throughput (e.g., the conveyor table 150A is processing more pieces of meat in a given unit of time than indicated in the threshold throughput), that may be an indication that the processing of meat on the conveyor table 150A may need to be slowed down. The higher throughout may overwhelm and create bottlenecks in the downstream processes. In some embodiments, the higher throughput may indicate that one or more workers at the conveyor table 150A are over performing or the number of workers at the conveyor table need to be reduced. In some embodiments, and particularly, if the controller 230 is also finding errors in the meat processing (e.g., foreign objects embedded within the meat, lean point not matching specification, etc.), that may be an indication that one or more workers may not be properly processing meat and may need to be trained.

Similarly, if the actual throughput is less than the threshold throughput, that may be indicative of under-performing workers, not enough number of workers at the conveyor table 150A, slower harvesting of meat, or another issue at the conveyor table that may be leading to a lower throughput. A lower throughput may slow down the downstream processes. Thus, an optimal throughput may be desired to ensure an optimum operation of processes. Thus, the comparison between the actual throughput and the threshold throughput may provide real-time feedback on whether the throughput is greater than or lower than the expected throughput (e.g., as indicated by the threshold throughput) and take action accordingly.

In some embodiments, at operation 655, the controller 230 may raise an alert if the actual throughput differs from the threshold throughput. In some embodiments, the alert may be raised on the dashboard associated with the conveyor table 150A. In some embodiments, the alert may also be sent to other stakeholders. In some embodiments, the operation of the conveyor table 150A may be stopped. The controller 230 may take other actions too. Upon raising the alert, the process 630 loops back to the operation 640 to continue measuring the actual throughput of the conveyor table 150A.

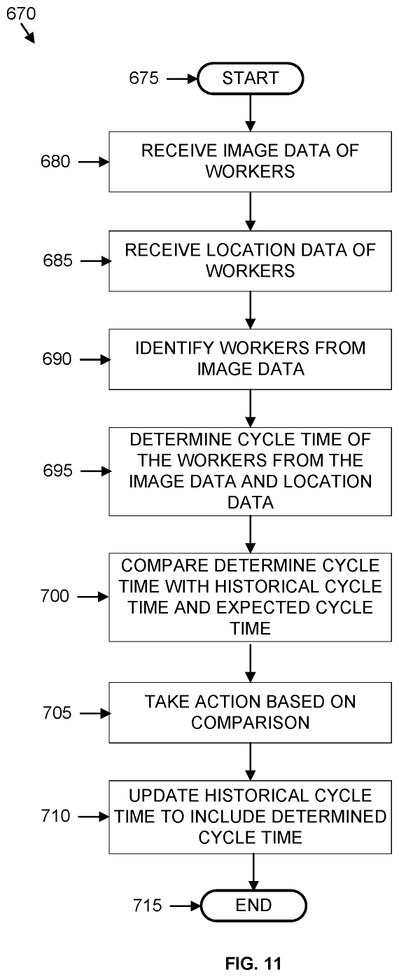

Turning now to FIG. 11, an example flowchart outlining operations of a process 670 is shown, In accordance with some embodiments of the present disclosure. The process 670 may be performed by the controller 230 for monitoring and providing real-time feedback on workers performance. The process 670 may include other or additional operations depending upon the particular embodiment. Thus, upon starting at operation 675, the controller 230 receives image data captured of the workers operating at a particular conveyor table at operation 680. In some embodiments, the image data may include video data. In other embodiments, the image data may include other or additional types of data. The description below is with respect to the workers 160A operating at the conveyor table 150A. However, the description below is also applicable to any workers operating at any conveyor table in the food processing facility 100.

Specifically, at operation 680, the computer vision system 170A may capture videos of the workers 160A as those workers are working on the conveyor table 150A. In some embodiments, the image data may include videos faces of the workers, body positions of the workers (e.g., the position of the limbs, the angle of tilt of the body with respect to the conveyor table 150A, etc.), the side (e.g., left or right) of the conveyor table on which the workers are standing, etc. In some embodiments, the computer vision system 170A may capture videos of each worker at the conveyor table 150A. At operation 685, the controller 230 receives location data of the workers 160A. In some embodiments, the controller 230 may receive the location data from location sensors associated with the workers 160A. In other embodiments, the controller 230 may receive the location data from other sources. At operation 690, the controller 230 may identify the workers from the image data. For example, in some embodiments, the controller 230 may apply a face detection algorithm to the image data to identify each worker at the conveyor table 150A. The controller 230 may then associate the detected faces with data that the controller may have received from the human resources system 257. For example, the controller 230 may identify the name of the workers, the employee identifier of the workers, any other information that may be needed or considered desirable to have.

At operation 695, the controller 230 also determines the cycles times of processing associated with each of the workers 160A. A cycle time may be the amount of time that a particular person takes in processing a piece of meat. For example, on the conveyor table 150A, the workers 160A are processing (e.g., trimming) meat. Thus, the cycle time may include the amount of time that each person on the conveyor table 150A takes to process (e.g., trim) one piece of meat. By determining the cycle times for workers, the efficiency of those workers may be determined. For example, if a worker has a lower cycle time than expected (e.g., is taking lesser time than expected), that worker may be considered highly efficient. If a worker has a higher cycle time than expected (e.g., is taking longer time than expected), that worker may be considered low efficient. Thus, by identifying the efficiency of each worker at a conveyor table, opportunities for improvement may be identified.

In some embodiments, the controller 230 determines the cycle times of each of the workers 160A from the image data, and particularly, from the body positions of the workers and the location data. For example, in some embodiments, the controller 230 may track positons of key body parts (e.g., head, hands, shoulders, etc.), positons of key implements (e.g., hook, knife, etc.) throughout the process. The controller 230 may graph or plot the movements and categorize the movements by operation. For example, in some embodiments, the controller 230 may categorize the operations as waiting for product, pulling product, processing product, etc. based on the tracked positions of the key body parts and implements. The controller 230 may then determine the cycle time based on the categorization. For example, in some embodiments, the controller 230 may determine the total time that a worker spends between waiting for one piece of meat and waiting for the next piece of meat. In some embodiments, the controller 230 may know the various operations that a worker performs in each cycle. Thus, in some embodiments, the controller 230 may sum the time that the worker spends performing each operation in a cycle to calculate the cycle time.

At operation 700, the controller 230 compares the calculated cycle time of each of the workers 160A with the expected cycle time and historical cycle time of those workers. Each task may be associated with an expected cycle time. Further, the DT system 265 and/or the ERP system 260 may have historical cycle time for the workers 160A. The historical cycle time may be an aggregate (e.g., average) of the cycle times of the workers 160A within a past predetermined period of time (e.g., previous week, previous month, etc.) for a particular task. The controller 230 may compare the actual cycle time of the workers 160A with the expected cycle time. If the actual cycle time of a particular one of the workers 160A is greater than the expected cycle time, the controller may determine that the worker is working at a lower efficiency. However, in some embodiments, there may be other factors that may be contributing to the lower efficiency. For example, if the particular worker is a new employee or new to the task, that worker may take longer to complete a task than expected. Thus, in some embodiments, the controller 230 may also compare the actual cycle time of each of the workers 160A with a historical cycle time of those workers. If the actual cycle time of a particular worker is greater than both the expected cycle time and the historical cycle time, it may indicate that the worker is performing at a lower efficiency than is typical for the workers.

Thus, if the actual cycle time of the workers 160A is greater than both the expected cycle time and the historical cycle time, at operation 705, the controller 230 may raise an alert or take some other action. For example, in some embodiments, the controller 230 may display current cycle times of the workers 160A and how that compares with other workers at the same conveyor table. In some embodiments, the controller 230 may send a notification to a manager of the workers 160A. In some embodiments, the controller 230 may also determine a current location of the workers 160A. For example, in some embodiments, certain workers may perform better when standing on a particular side (e.g., left or right) of the conveyor table. The controller 230 may determine which side of the conveyor table 150A each of the workers 160A are standing using the location data of the operation 685. Based on the location data, the controller 230 may determine a current location of the workers 160A. The controller 230 may then compare the current location of the workers 160A with an expected location of that workers relative to the conveyor table 150A. In some embodiments, upon determining that a particular worker was expected to stand on a first side (e.g., left or right) of the conveyor table 150A but is standing on a second side (e.g., right or left) of that conveyor table, the controller may raise an alert alerting the worker that they need to change their position. The process 670 ends at operation 715.

Turning now to FIG. 12, an example screenshot 720 of data that may be shown on a dashboard (e.g., the dashboard 305) is shown, in accordance with some embodiments of the present disclosure. It is to be understood that the type of data that is shown on the screenshot 720, the orientation and placement of the size, as well as the stylistic features of the data are only an example and not intended to be considered limiting in any way. In some embodiments, the dashboard with which the screenshot 720 is associated may be displayed at the end of a conveyor table. The screenshot 720 shows real time data including a progress bar 725 showing a total number of pieces of meat processed so far by a particular conveyor table out of the total number of pieces to be processed, an actual number of pieces processed 730, the total number of pieces to be processed 735, a time 740 until the current shift ends and in which the total number of pieces need to be processed, a graphical representation 745 showing real-time actual performance 750 versus an expected performance 755 of the workers on the associated conveyor table. In some embodiments, the graphical representation 745 may assume other forms. The screenshot 720 also shows a choice scale 760. That choice scale 760 shows the yield performance over the course of the day in terms of dollars captured and compares it against the expected yield. Yield may be dollarized in the choice scale 760 to give the employees a metric they can relate to. The dashboard may show other or additional data in other embodiments.

Thus, the present disclosure provides a smart manufacturing system having a plurality of computer vision systems and sensors that collect data on workers, conveyor tables, meat, etc. and track packaged, and unpackaged products quality and yield as product. The smart manufacturing system may track and trend quality defects and yield performance. The smart manufacturing system may continuously monitor product quality and yield parameters and display real-time performance to front line production teams via digital performance boards, notify appropriate management personnel via mobile devices if tolerances exceed an established threshold requiring immediate action, or automatically reject to a rework area if action cannot wait for a manual response. The smart manufacturing system may also provide an initial course of action using inputs from various input devices to determine if a defect or drop in performance is related to a machine condition issue, an individual's performance, foreign object detected, etc.

For example, as product is trimmed and deboned, waste stream conveyors containing trimmings and bones may be continuously monitored for the amount of meat that is not removed as the value may be diminished if not recovered in primary processing. Computer vision systems continuously monitor and provide real-time feedback to workers allowing them to make self adjustments. The smart manufacturing system provides supervision with insights into where meat is not being preserved and if it is due to workmanship or if the process is not running at an optimal speed. Additionally, the smart manufacturing system monitors all conveyor tables and automatically sorts meat based on their measured lean point to establish a known lean point of each combo. The production floor teams may receive real-time feedback on their digital performance boards. Management may also have access to this same real-time information, and may additionally be able to see historical performance by multiple factors (day, year, employee, supervisor, etc.). Additionally, management may receive alarms via mobile devices if trends are not addressed within a given amount of time and may be notified if a significant event occurs that created a stoppage in production or requires product to be removed (e.g., foreign object detected).

In some embodiments, trim is received from the fabrication floor in combos and is identified by the ratio of fat to lean. Based on the product being made, and the amount of lean required, combos containing varying amounts of lean and fat may be used. Product then flows metal detection and into primary grinding prior to entering blending/mixing where the final lean point is achieved. After mixing is complete, the product then moves to a final grind step before passing through another metal detector and then on to packaging (chub format). After packaged the product is manually inspected for fat smears (undistributed, large pieces of fat), leakers (packages where vacuum hasn't been preserved) and weight. The smart manufacturing system continuously monitors conveyor speeds, load/unload/cycle times, metal detector rates (as well as time between metal detector checks and pass/fail history), grinding speeds and motor load, incoming product specs (lean: fat), etc., monitor lean: fat ratio, as well as monitor for low density foreign objects (gloves, wood, plastic) from the moment the meat starts processing, through mixing/blending and through grinding. The smart manufacturing system may be monitoring process speeds, continuously measuring product lean point, inspecting for foreign objects and ensuring finished product meets product quality specs for lean point, appearance, integrity of packaging and within finished product weight specification.

In some embodiments, products are monitored exiting packaging machines and where the product type can be identified/confirmed and the integrity of the package can be evaluated (looking for air in the bag). Products that do not pass this inspection may be automatically delivered to a rework station to be unpackaged and returned to packaging. Rework rates would be continuously monitored and displayed on real-time performance boards for the packaging machine operators and leverage machine performance and process rate information to make recommendations for adjustments or repairs if rates exceed an established threshold. Production management and maintenance may be notified or persistence conditions exists that create the likelihood of rework. Once product makes it to case packing (packaged product is placed in a box), each box is monitored for the correct products and the correct number/weight of products. If the bar code scanning of the label on the box doesn't match the products that are inside the case, then box is automatically rejected to a rework station to be inspected and corrected. Rework may be monitored by employee and tracked by cause (too much product, wrong product, foreign objects, etc.) to create notifications to management depending on severity and frequency of occurrence.

In some embodiments, the DT system may be an electronic simulation of the production processes in the food processing facility which utilizes inputs from the daily make sheet, machine capabilities, production line staffing levels and job tasks cycle times to illustrate when and where production challenges may occur due to the combination of those factors. Providing real-time information of machine speeds, personnel task speed, etc. into the DT system may increase the accuracy so that production planning teams can make informed decisions to optimize how facilities are running and improve predictions of future production runs by comparing predictive performance with actual and adjusting the artificial intelligence algorithms to improve modeling accuracy. Computer vision systems may provide the DT system with real-time individual cycle time performance to insure the single largest variable and constraint of the process (labor) is understood. In some embodiments, predictive labor analytics may be combined with actual make sheet and production asset capabilities to model where we are likely to see production challenges (e.g., bottlenecks and stoppages) due to this combination of product mix, asset capabilities and labor constraints. The tact/cycle time of individual employees in the DT system may be based off of standards for those roles, so leveraging real tact/cycle times by specific employee with increase the accuracy of the model and provide insights into training and personnel placement opportunities, recommended speed to run production to optimize yield, productivity, as well as safety. Actual versus recommended production speed may be monitored by plant personnel and adherence to the modeled speed would be a key performance metric.

In some embodiments, computer vision systems may work with connected machine sensors to detect changes in product/package spacing and machine speeds to monitor lines for throughput rate and alert alert/notify plant personnel through digital performance boards and mobile devices of process bottlenecks and downtime and would also provide some guidance on the cause (e.g., machine not running at rate, employee underperforming task, problem in another area, etc.). The computer vision systems may monitor piece flow by production table and packaging machine to monitor real-time productivity, adherence to plan and real-time yields with results being displayed on shop floor performance boards notifying key personnel via mobile devices if metrics drop below an established threshold and providing guidance on recommended corrective actions (e.g., slow down, speed up, adjust labor in area x, etc.).

In addition to the use cases discussed above, in some embodiments, the smart manufacturing system of the present disclosure may be used for monitoring required activities for completion and frequency (e.g., knife sterilization, rice paper placement, etc.), generate alerts when critical stations are left unattended or performance is below a threshold, analyze the movement of workers, sanitization and other activities to identify inefficiencies and waste, placement of works across the production floor, open positions/stations, prevent unqualified/unauthorized works from entering certain parts of the facility, safety monitoring (e.g., unsafe behaviors, personal protective equipment use, knife placement, etc.).

Further, although FIGS. 4-11 describe individual processes, in some embodiments, one or more of those processes may be combined together and the controller may perform those processes simultaneously. For example, in some embodiments, the controller may be configured to both monitor meat on the conveyor tables for foreign objects, trim composition, sorting, packaging, waste trims, etc. as well as monitor personnel for performance.

The various illustrative logical blocks, circuits, modules, routines, and algorithm steps described in connection with the embodiments disclosed herein can be implemented as electronic hardware, or combinations of electronic hardware and computer software. To clearly illustrate this interchangeability, various illustrative components, blocks, modules, and steps have been described above generally in terms of their functionality. Whether such functionality is implemented as hardware, or as software that runs on hardware, depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a general purpose processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A control processor can synthesize a model for an FPGA. For example, the control processor can synthesize a model for logical programmable gates to implement a tensor array and/or a pixel array. The control channel can synthesize a model to connect the tensor array and/or pixel array on an FPGA, a reconfigurable chip and/or die, and/or the like. A general purpose processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances, where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. A method comprising:
receiving, by a controller, image data captured from a product traveling on a conveyor table in a food processing facility;
determining, by the controller, at least one of a presence of a foreign object embedded within the product, a trim composition of the product, or an amount of meat on the product based on variations in texture and/or color identified from the image data; and
taking, by the controller, an action based on the determined presence of the foreign object embedded within the product, the trim composition of the product, or the amount of meat on the product.

2. The method of claim 1, further comprising:
determining, by the controller, the presence of the foreign object in the product based upon identifying portions in the product where the texture and/or color is different from the texture and/or color of surrounding portions; and
stopping, by the controller, the conveyor table upon detecting the foreign object in the product.

3. The method of claim 2, further comprising raising an alert indicating detection of the foreign object.

4. The method of claim 1, further comprising:
determining, by the controller, the trim composition of the product by determining a first area of the product having a first variation in the texture and/or color and a second area of the product having a second variation in the texture and/or color, wherein the first area is indicative of a lean content in the product and the second area is indicative of a fat content in the product; and
activating, by the controller, a diverter gate associated with the conveyor table to sort the product into one of a plurality of combos based on the determined trim composition.

5. The method of claim 1, further comprising:
determining, by the controller, the trim composition of the product by determining a first area of the product having a first variation in the texture and/or color and a second area of the product having a second variation in the texture and/or color, wherein the first area is indicative of a lean content in the product and the second area is indicative of a fat content in the product;
comparing, by the controller, the trim composition of the product with an expected trim composition of the product; and
raising, by the controller, an alert upon determining that the trim composition of the product does not meet the expected trim composition of the product.

6. The method of claim 5, further comprising;
determining, by the controller, whether an alert threshold is reached upon determining that the trim composition of the product does not meet the expected trim composition of the product; and
raising, by the controller, the alert upon determining that the alert threshold is reached.

7. The method of claim 1, further comprising:
determining, by the controller, the amount of meat on the product by determining a first area of the product having a first variation in the texture and/or color and a second area of the product having a second variation in the texture and/or color, wherein the first area is indicative of the amount of meat in the product and the second area is indicative of the amount of bone in the product; and
raising, by the controller, an alert upon determining that the amount of meat on the product is greater than a predetermined threshold.

8. A method comprising:
receiving, by a controller, image data captured from a vacuum sealed package moving on a conveyor table in a food processing facility;
determining, by the controller, a defect inside the vacuum sealed package based on the image data;
activating, by the controller, a diverter gate to divert the vacuum sealed package for repackaging upon detecting the defect in the vacuum sealed package;
computing, by the controller, a rework rate based upon a number of packages that are diverted for repackaging upon diverting the vacuum sealed package for repackaging; and
raising, by the controller, an alert upon determining that the rework rate is greater than a threshold rework rate.

9. The method of claim 8, wherein the image data comprises a mass spectrometer image.

10. The method of claim 8, further comprising:
determining, by the controller, a first boundary of a packaging material in the vacuum sealed package from the image data;
determining, by the controller, a second boundary of a food product inside the vacuum sealed package from the image data;
determining, by the controller, presence of air inside the vacuum sealed package upon determining that a gap of a predetermined threshold exists between the first boundary and the second boundary; and
activating, by the controller, the diverter gate to divert the vacuum sealed package for repackaging upon detecting the presence of air.

11. The method of claim 8, wherein raising the alert comprises displaying the rework rate on a dashboard associated with the conveyor table.

12. The method of claim 11, further comprising displaying the defect that caused the diverting of the vacuum sealed product for repackaging.

13. The method of claim 8, further comprising:
determining, by the controller, a variation in a texture and/or color from the image data for identifying a fat smear, wherein the texture and/or color of the fat smear varies from the texture and/or color of an area surrounding the fat smear; and
activating, by the controller, the diverter gate to divert the vacuum sealed package for repackaging upon detecting the presence of fat smear.

14. A system comprising:
a first computer vision system to capture first image data from a product travelling on a first conveyor table in a food processing facility;
a second computer vision system to capture second image data from a worker working at the first conveyor table;
a memory having computer-readable instructions stored thereon; and
a processor that executes the computer-readable instructions to:
detect a condition associated with the product from the first image data based at least on a variation in texture and/or color in the first image data;
detect an actual cycle time associated with the worker from the second image data based at least on body positions of the worker identified from the second image data; and
take action based on the condition and the cycle time.

15. The system of claim 14, wherein the condition comprises a foreign object embedded within the product, and wherein upon detecting the foreign object embedded within the product, the action comprises stopping the first conveyor table.

16. The system of claim 14, wherein the condition comprises an actual trim composition of the product, and wherein the action comprises raising an alert upon determining that the actual trim composition varies from an expected trim composition of the product.

17. The system of claim 14, further comprising:
a third computer vision system to capture third image data from the product travelling on a second conveyor table in the food processing facility, and wherein the processor further executes computer-readable instructions to:
determine an actual trim composition of the product from the third image data based at least on an additional variation in texture and/or color in the third image data; and
activate a diverter gate to sort the product into one of a plurality of combos based on the actual trim composition.

18. The system of claim 14, wherein the processor further executes computer-readable instructions to:
determine a speed at which the first conveyor table is moving;
determine a throughout of the first conveyor table based upon the first image data and the speed at which the first conveyor table is moving; and
raise an alert upon determining that the throughout differs from an expected throughput.

19. The system of claim 14, wherein the processor further executes computer-readable instructions to:
compare the actual cycle time of the worker with an expected cycle time;
compare the actual cycle time of the worker with a historical cycle time of the worker; and
raise an alert upon determining that the actual cycle time of the worker varies from the expected cycle time and the historical cycle time of the worker.

20. The system of claim 14, wherein the processor further executes computer-readable instructions to:
receive location data associated with the worker;
determine a current location of the worker relative to the first conveyor table based on the location data;
determine that the current location of the worker varies from the expected location of the worker relative to the first conveyor table; and
raise an alert upon determining that the current location of the worker varies from the expected location of the worker.
